(19) United States
(12) Patent Application Publication
(10) Pub. No.: US 2009/0061114 A1
(43) Pub. Date: Mar. 5, 2009

(54) Anti-reflection film, polarizing plate, and liquid crystal display device

(75) Inventor: Takumi Ando, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/659,425

(22) PCT Filed: Sep. 6, 2005
(86) PCT No.: PCT/JP2005/016690

§ 371 Date: Feb. 5, 2007

(30) Foreign Application Priority Data
Sep. 13, 2004 (JP) 2004-265401

(51) Int. Cl. C09K 19/52; B32B 5/02; G02B 5/30; G02F 1/1335

(52) U.S. Cl. 428/1.1; 428/143; 359/485; 349/96

(57) ABSTRACT

An anti-reflection film comprising: a support comprising a transparent resin; at least one hard coat layer comprising an ionizing-radiation curable resin; and a low refractive index layer disposed as an outermost layer, in this order, wherein (i) a mixed region in which the transparent resin of the support and the ionizing-radiation curable resin of the hard coat layer are mixed is provided between the support and the hard coat layer; (ii) the anti-reflection film has a surface roughness Ra (center line average roughness) of 0.10 mm or less; and (iii) the low refractive index layer comprises a hollow silica microparticle having an average particle diameter of 5 to 200 nm and a refractive index of 1.17 to 1.40.

### TECHNICAL FIELD

The present invention relates to a display device for use in an image display of a computer, a word processor, a television, or the like, and more particularly, to an anti-reflection film, a polarizing plate, and a liquid crystal display device which improve display quality.

### BACKGROUND ART

In a display device, such as a cathode-ray tube (CRT), a plasma display (PDP), an electroluminescence display (ELD), or a liquid crystal display device (LCD), an anti-reflection film, which employs principles of optical diffusion and optical interference, is typically disposed on an outermost surface of the display in order to prevent a reduction in contrast or image reflection due to reflection of external light, thereby improving image visibility.

The related-art anti-reflection films include an anti-glare, anti-reflection film, which diffuses surface-reflected light to reduce regular reflection of external light and thereby to prevent reflection of surroundings. For example, in an anti-reflection film of Japanese Unexamined Patent Publication No. 2000-338310, a hard coat layer contains a suitable microparticle in order to render its surface rough to diffuse external light and thereby to reduce on-screen glares. Also, in anti-reflection films of Japanese Unexamined Patent Publication Nos. 2002-196117 and 2003-161816, a low refractive index layer is provided on an anti-glare hard coat layer with fine surface roughness, in order to reduce reflectance by utilizing the principle of optical interference as well as by diffusing external light on the surface. Further, in an anti-reflection film of Japanese Unexamined Patent Publication No. 2003-121620, a high refractive index layer is provided below a low refractive index layer in order to effectively utilizing optical interference to reduce reflection of external light.

Whereas these anti-glare, anti-reflection films diffuse external light on their finely rough surfaces, there are unavoidable problems such as a whitish display screen (white blurring), a reduction in image sharpness (image blurring), and glare resulting from the lens effect of the finely rough structures. To address these problems, attempts have been made to achieve an improvement by controlling the haze of an anti-glare layer, image sharpness, fine roughness, or the like. However, a satisfactory result has not been obtained.

On the other hand, an anti-reflection film with extremely fine surface roughness or a flat surface has been proposed as one with high image sharpness and no white blurring or glare. Japanese Unexamined Patent Publication No. 2003-75603 proposes an anti-reflection film having a laminated structure in which a medium refractive index layer, a high refractive index layer, a low refractive index layer are formed on a base film in this order, the anti-reflection film having no finely rough surface structure and utilizing only optical interference. Also, Japanese Unexamined Patent Publication No. 2003-57415 proposes an anti-reflection film having a hard coat layer which is provided with an internal scattering capability while its surface roughness is kept extremely low, whereby it is possible to achieve a sharp image and improve viewing angle characteristics. However, in any of the above-described films, the refractive index of the outermost-surface low refractive index layer is not satisfactorily low, and therefore, a satisfactory level of visibility is not attained in a bright room.

Also, there has been an attempt to reduce the refractive index of the outermost-surface low refractive index layer, thereby enhancing anti-reflection performance. Japanese Unexamined Patent Publication No. 2002-317152 proposes an anti-reflection film in which a low refractive index layer containing a hollow silica microparticle is applied on a hard coat layer with a smooth surface containing no particles in order to improve an anti-reflection capability by the effect of the hollow silica microparticle that reduces the refractive index.

However, the reduction in refractive index of the low refractive index layer by the hollow silica microparticle is extremely effective in reducing the reflectance of the anti-reflection film, but simultaneously increases a difference in refractive index between the low refractive index layer and the underlying hard coat layer, resulting in a noticeable irregular interference pattern in the hard coat layer. The irregular interference pattern in the hard coat layer is a phenomenon in which a rainbow pattern appears due to interference between light reflected on an interface of the hard coat layer and the support and light reflected on an interface of the hard coat layer and the low refractive index layer. As the difference in refractive index between the interfaces increases, the interference is increased, so that the rainbow pattern becomes more noticeable. Accordingly, when a smooth hard coat layer is used, a mere reduction in refractive index of the low refractive index layer conversely reduces display visibility, and also spoils display appearance.

### DISCLOSURE OF THE INVENTION

An object of the present invention is to provide an anti-reflection film which prevents reflection of external light, eliminates white blurring, image blurring, and a glare phenomenon, and is improved against a rainbow pattern to improve display visibility of a liquid crystal display device or the like.

Another object of the present invention is to provide an anti-reflection film having satisfactory anti-reflection performance and improved abrasion resistance.

Still another object of the present invention is to provide a polarizing plate and a liquid crystal display device using the same, and the polarizing plate achieves high visibility by an anti-reflection film, widens the viewing angle (particularly downward viewing angle), and substantially eliminates contrast reduction, gradation or black-and-white inversion, and variation in hue due to change of visual angle.

The above objects of the present invention are achieved by an anti-reflection film as specified below in 1 to 11, a polarizing plate as specified below in 12 and 13, and a liquid crystal display device as specified below in 14 to 16.

1. An anti-reflection film comprising: a support comprising a transparent resin; at least one bard coat layer comprising an ionizing-radiation curable resin; and a low refractive index layer disposed as an outermost layer, in this order, wherein

(i) a mixed region in which the transparent resin of the support and the ionizing-radiation curable resin of the hard coat layer are mixed is provided between the support and the hard coat layer;

(ii) the anti-reflection film has a surface roughness Ra (center line average roughness) of 0.10 μm or less; and

(iii) the low refractive index layer comprises a hollow silica microparticle having an average particle diameter of 5 to 200 nm and a refractive index of 1.17 to 1.40.

2. The anti-reflection film of 1, wherein the hard coat layer and/or the low refractive index layer contain (a) a hydrolysate of organosilane and/or a partial condensate thereof, the organosilane containing a hydroxyl group or a hydrolyzable group directly linked with silicon, and (b) at least one type of metal chelate compound having, as a central metal, a metal selected from Zr, Ti, and Al, and having, as ligands, an alcohol represented by a general formula R³OH (where R³ represents an alkyl group having one to ten carbon atoms) and a compound represented by a general formula R⁴COCH₂COR⁵ (where R⁴ represents an alkyl group having one to ten carbon atoms, and R⁵ represents an alkyl group having one to ten carbon atoms or an alkoxy group having one to ten carbon atoms).

3. The anti-reflection film of 1 or 2, wherein the mixed region has a layer thickness of 0.2 to 10 μm.

4. The anti-reflection film of any of 1 to 3, wherein the support is a cellulose acylate film.

5. The anti-reflection film of any of 1 to 4, wherein the hard coat layer is formed by applying, drying, and curing a coating solution containing a solvent for dissolving or swelling the transparent resin of the support.

6. The anti-reflection film of any of 1 to 5, wherein the hard coat layer is formed by coating a coating composition containing at least an ionizing radiation-curable resin and a solvent, and drying with drying air at a flowing rate of from 0.1 to 10 m/second.

7. The anti-reflection film of any of 1 to 6, wherein the hard coat layer has a refractive index of 1.55 or more.

8. The anti-reflection film of any of 1 to 7, wherein the hard coat layer contains a binder and at least one type of translucent particle having a refractive index different from that of the binder.

9. The anti-reflection film of any of 1 to 8, wherein the anti-reflection film has a degree of transmission image sharpness of 60% or more.

10. The anti-reflection film of any of 1 to 9, wherein the hard coat layer has a haze value of 10% or more.

11. The anti-reflection film of any of 1 to 10, wherein, in a scattered light profile of the hard coat layer measured by a goniophotometer, an intensity of scattered light having an emission angle of 30° is 0.01% to 0.2% of an intensity of light having an emission angle of 0°.

12. A polarizing plate comprising a polarizing film having two surfaces sandwiched between protection films, wherein one of the protection films is the anti-reflection film of any of 1 to 11.

13. The polarizing plate of 12, wherein the other protection film that is not the anti-reflection film is an optical compensation film having an optically anisotropic layer, the optically anisotropic layer is a layer containing a compound having a discotic structural unit, the discotic structural unit has a disc surface inclined with respect to a surface of the protection film, and an angle made by the disc surface of the discotic structural unit and the surface of the protection film varies in a depth direction of the optically anisotropic layer.

14. A liquid crystal display device comprising the anti-reflection film of any of 1 to 11 or the polarizing plate of 12 or 13 as a top surface layer of a display.

15. A liquid crystal display device comprising the anti-reflection film of any of 1 to 11 or the polarizing plate of 12 as a top surface layer of a display having a liquid crystal cell of VA mode or IPS mode.

16. A liquid crystal display device comprising the anti-reflection film of any of 1 to 11 or the polarizing plate of 12 or 13 as a top surface layer of the display having a liquid crystal cell of OCB mode.

### BRIEF DESCRIPTION OF THE DRAWINGS

FIG. 1 is a schematic cross-sectional view illustrating an exemplary structure of an embodiment of an anti-reflection film according to the present invention;

FIG. 2 is a schematic cross-sectional view illustrating an exemplary structure of another embodiment of the anti-reflection film of the present invention; and

FIG. 3 is a schematic cross-sectional view illustrating an exemplary structure of still another embodiment of an anti-reflection film according to the present invention.

1 denotes a transparent support; 2A, 2B, 2C denote hard coat layers; 3 denotes a low refractive index layer; 4 denotes a mixed region; 5 denotes a translucent particle; 6 denotes a medium refractive index layer; 7 denotes a high refractive index layer; and 10, 20, 30 denote anti-reflection films.

### BEST MODE FOR CARRYING OUT THE INVENTION

Hereinafter, embodiments of an anti-reflection film according to the present invention will be first described with reference to the accompanying drawings.

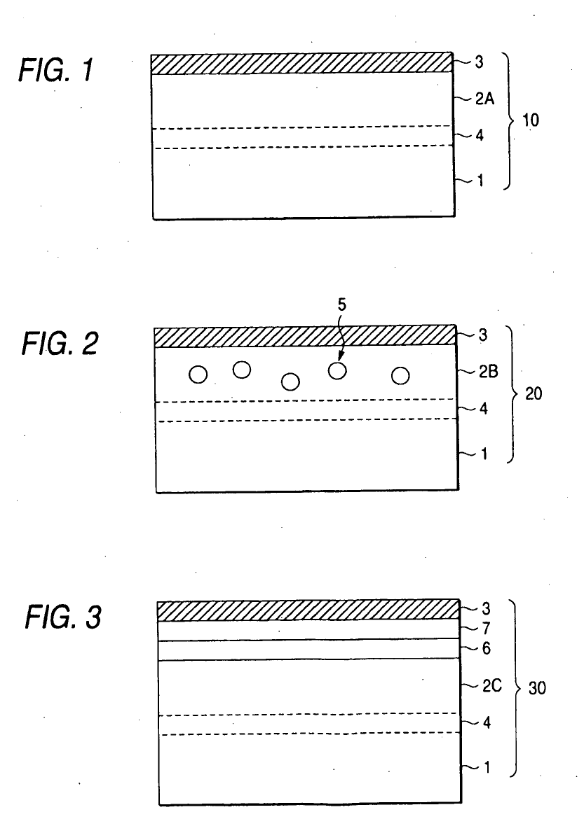

FIGS. 1 to 3 schematically illustrate cross-sectional views of exemplary structures of the anti-reflection film of the present invention. As shown in FIG. 1, an anti-reflection film 10 of the present invention is formed by laminating a transparent support 1, a hard coat layer 2A, and a low refractive index layer 3, as the outermost layer, containing a hollow silica microparticle, and has a mixed region 4 between the transparent support 1 and the hard coat layer 2A. The mixed region is a region which is generated after applying, drying, and curing the hard coat layer on the transparent support, in which a transparent resin of the support and an ionizing-radiation curable resin of the hard coat layer are mixed together.

The form of each layer and the layer composition of the film can be changed as appropriate. For example, as exemplified by an anti-reflection film 20 illustrated in FIG. 2, a translucent particle 5 capable of conferring an internal scattering capability may be contained in a hard coat layer 2B, or as exemplified by an anti-reflection film 30 illustrated in FIG. 3, a medium refractive index layer 6 and a high refractive index layer 7 may be provided on a hard coat layer 2C for the purpose of enhancing an anti-reflection capability by optical interference, and a low refractive index layer 3 may be disposed as an outermost layer.

Next, each layer included in the anti-reflection film of the present invention will be described in detail. Note that the description “(numeral value A) to (numeral value B)” as used herein, which represents physical property values or characteristic values, indicates “greater than or equal to(numeral value A) and smaller than or equal to (numeral value B)”.

(Transparent Support)

Examples of the transparent support of the anti-reflection film of the present invention include, but are not particularly limited to, a transparent resin film, a transparent resin plate, a transparent resin sheet, transparent glass, and the like. Examples of the transparent resin film include a cellulose acylate film (e.g., a cellulose triacetate film (refractive index: 1.48), a cellulose diacetate film, a cellulose acetate butyrate film, a cellulose acetate propionate film), a polyethylene terephthalate film, a polyether sulfone film, a polyacrylic resin film, a polyurethane resin film, a polyester film, a polycarbonate film, a polysulfone film, a polyether film, a polymethylpentene film, a polyether ketone film, a (meth)acrylonitrile film, and the like.

Among them, a cellulose acylate film is preferable which has high transparency and optically low birefringence, is easily manufactured, and is generally used as a protection film for a polarizing plate. A cellulose triacetate film is particularly preferable. The transparent support is typically about 25 μm to 1000 μm in thickness.

The cellulose acylate for use in the present invention is preferably made of cellulose acetate having an acetic acid content of 59.0 to 61.5%.

The acetic acid content means the amount of acetic acid bonded per unit mass of cellulose. The acetic acid content is determined according to the measurement and calculation of acetic acid content described in ASTM: D-817-91 (test method of cellulose acetate, etc.).

The viscosity-average degree of polymerization (DP) of cellulose acylate is preferably 250 or more, more preferably 290 or more.

The cellulose acylate for use in the present invention preferably has a Mw/Mn (Mw is a mass average molecular weight and Mn is a number average molecular weight) close to 1.0 as measured by gel permeation chromatography, i.e., a narrow molecular weight distribution. Specifically, the Mw/Mn value is preferably from 1.0 to 1.7, more preferably from 1.3 to 1.65, and most preferably from 1.4 to 1.6.

Generally, the hydroxyl groups at the 2-position, 3-position and 6-position of cellulose acylate are not evenly distributed in ⅓ portions of the entire substitution degree, but the substitution degree of the hydroxyl group at the 6-position is liable to become small. The substitution degree of the hydroxyl group at the 6-position of cellulose acylate is preferably larger than those at the 2-position and the 3-position.

The hydroxyl group at the 6-position is preferably substituted with an acyl group to account for 32% or more, more preferably 33% or more, and particularly preferably 34% or more, of the entire substitution degree. The substitution degree of the acyl group at the 6-position of cellulose acylate is preferably 0.88 or more. The hydroxyl group at the 6-position may be substituted with an acyl group having 3 or more carbon atoms (e.g., a propionyl, a butyroyl group, a valeroyl group, a benzoyl group, or an acryloyl group) in addition to an acetyl group. The substitution degree at each position can be determined by NMR.

Cellulose acetate usable as the cellulose acylate of the present invention is obtained in accordance with methods described in Examples of Japanese Unexamined Patent Publication No. H11-5851, specifically, Synthesis Example 1 (paragraphs 0043 to 0044), Synthesis Example 2 (paragraphs 0048 to 0049), and Synthesis Example 3 (paragraphs 0051 to 0052).

(Production of Cellulose Acylate Film)

The cellulose acylate film for use in the present invention can be produced by a solution film formation process (solvent-casting method). In the solvent-casting method, the film is produced using a solution (dope) obtained by dissolving cellulose acylate in an organic solvent.

The organic solvent preferably includes a solvent selected from ethers having three to twelve carbon atoms, ketones having three to twelve carbon atoms, esters having three to twelve carbon atoms, and halogenated hydrocarbons having one to six carbon atoms. Two or more types of organic solvents may be mixed and used.

The ethers, ketones, and esters may have a cyclic structure. Compounds having any two or more functional groups of the ethers, ketones, and esters (i.e., —O—, —CO—, and —COO—) can also be used as the organic solvent. The organic solvent may have any other functional group, such as an alcoholic hydroxyl group. In the case of an organic solvent having two or more types of functional groups, the number of carbon atoms thereof may fall within the above-specified preferable range for a compound having any of the functional groups.

Examples of the ethers having three to twelve carbon atoms include diisopropyl ether, dimethoxymethane, dimethoxyethane, 1,4-dioxane, 1,3-dioxolane, tetrahydrofuran, anisole, and phenetole.

Examples of the ketones having three to twelve carbon atoms include acetone, methyl ethyl ketone, diethyl ketone, diisobutyl ketone, cyclohexanone, and methylcyclohexanone.

Examples of the esters having three to twelve carbon atoms include ethyl formate, propyl formate, pentyl formate, methyl acetate, ethyl acetate, and pentyl acetate.

Examples of the organic solvent having two or more types of functional groups include 2-ethoxyethyl acetate, 2-methoxyethanol, and 2-butoxyethanol.

The halogenated hydrocarbons have preferably one or two carbon atoms, and most preferably one carbon atom. The halogen in the halogenated hydrocarbons is preferably chlorine. The proportion of hydrogen atoms substituted with halogen of the halogenated hydrocarbons is preferably 25 to 75 mol %, more preferably 30 to 70 mol %, even more preferably 35 to 65 mol %, and most preferably 40 to 60 mol %. One typical example of the halogenated hydrocarbons is methylene chloride.

A cellulose acylate solution (dope) can be prepared in a general method. The general method means that treatment is carried out at a temperature of 0° C. or more (ordinary temperature or high temperature). The solution can be prepared using a method and a device which are used to prepare a dope in a typical solvent-casting method. Note that, in the general method, halogenated hydrocarbon (especially, methylene chloride) is preferably used as the organic solvent. Alternatively, it is possible to use a non-chlorinated solvent, such as that described in Journal of Technical Disclosure No. 2001-1745 issued by Japan Institute of Invention and Innovation.

The amount of cellulose acylate is adjusted so as to be 10 to 40% by mass in a resultant solution. More preferably, the amount of cellulose acylate is 10 to 30% by weight. Any additive as described below may be added to the organic solvent (main solvent).

The solution can be prepared by stirring a mixture of cellulose acylate and the organic solvent at ordinary temperature (0 to 40° C.). The high-concentration solution may be stirred under pressure and heat. Specifically, the cellulose acylate and the organic solvent are placed into a pressure vessel, which is in turn sealed, followed by stirring under pressure while heating to the boiling point (under atmospheric pressure) or higher of the solvent but within a range in which the solvent does not boil. The heating temperature is typically 40° C. or more, preferably 60 to 200° C., and more preferably 80 to 110° C.

The components may be roughly premixed together before being placed into the vessel. Alternatively, they may be placed into the vessel in sequence.

The vessel needs to be structured so as to allow stirring. The vessel can be pressurized by introducing thereinto inert gas, such as nitrogen gas. Also, an increase in vapor pressure by heating the solvent may be utilized. Alternatively, each component may be added under pressure after the vessel is sealed.

The vessel may be preferably externally heated as required. For example, a jacket-type heating device can be used. Alternatively, it is possible to provide a plate heater outside the vessel and circulate a liquid through a pipe provided thereto to heat the entire vessel.

Preferably, a stirring blade is provided in the vessel to allow stirring. The stirring blade is preferably long enough to reach near a wall of the vessel. It is preferable to provide a scraping blade to an edge of the stirring blade in order to renew a liquid film on the wall of the vessel.

The vessel may be equipped with meters, such as a pressure gauge, a thermometer, and the like. In the vessel, each component is dissolved in the solvent. A prepared dope is cooled before being removed from the vessel, or is cooled with a heat exchanger or the like after removal thereof.

The solution can also be prepared by a cooling dissolution method. In the cooling dissolution method, cellulose acylate can be dissolved even in an organic solvent in which it is difficult to dissolve using an ordinary dissolution method. Note that even for solvents in which cellulose acylate can be dissolved by an ordinary dissolution method, the cooling dissolution method is effective in quickly producing a homogeneous solution.

In the cooling dissolution method, initially, cellulose acylate is gradually added to an organic solvent at room temperature while stirring.

Preferably, the amount of cellulose acylate is adjusted so as to be 10 to 40% by mass in the resultant mixture. More preferably, the amount of cellulose acylate is 10 to 30% by mass. Further, any additive as described below may be added to the mixture.

Next, the mixture is cooled to −100 to −10° C. (preferably −80 to −10° C., more preferably −50 to −20° C., and most preferably −50 to −30° C.). The cooling can be carried out in, for example, a dry ice/methanol bath (−75° C.) or a cooled diethylene glycol solution (−30 to −20° C.). The thus-cooled mixture of cellulose acylate and the organic solvent is solidified.

The cooling rate is preferably 4° C./min or more, more preferably 8° C./min or more, and most preferably 12° C./min or more. A higher cooling rate is preferable, however, the theoretical uppermost limit thereof is 10000° C./sec, the technical uppermost limit thereof is 1000° C./sec, and the practical uppermost limit thereof is 100° C./sec. Note that the cooling rate is a value obtained by dividing the difference between a temperature at which the cooling is started and a final cooling temperature by a period of time from when the cooling is started to when the final cooling temperature is reached.

Further, if heating is carried out to 0 to 200° C. (preferably 0 to 150° C., more preferably 0 to 120° C., and most preferably 0 to 50° C.), cellulose acylate dissolves in an organic solvent. The increase in temperature may be achieved by allowing the mixture to stand at room temperature or by heating in a warm bath.

The heating rate is preferably 4° C./min or more, more preferably 8° C./min or more, and most preferably 12° C./min or more. A higher heating rate is preferable, however, the theoretical uppermost limit thereof is 10000° C./sec, the technical uppermost limit thereof is 1000° C./sec, and the practical uppermost limit thereof is 100° C./sec. Note that the heating rate is a value obtained by dividing the difference between a temperature at which the heating is started and a final heating temperature by a period of time from when the cooling is started to when the final heating temperature is reached.

In the above-described manner, a homogeneous solution is obtained. If dissolution is insufficient, cooling and heating operations may be repeated. Whether dissolution is sufficient or not can be judged only by visually observing the appearance of the solution.

In the cooling dissolution method, it is desirable to use a sealed vessel in order to prevent water from entering the vessel due to dew condensation during cooling. Also, in the cooling and heating operations, pressure application during the cooling and pressure reduction during the heating make it possible to reduce a time required for dissolution. In order to carry out the pressure application and pressure reduction, it is desirable to use a pressure-resistant vessel.

Note that according to differential scanning calorimetry (DSC), a 20%-by-mass solution obtained by dissolving cellulose acetate (acetic acid content: 60.9%, viscosity average polymerization degree: 299) in methyl acetate by a cooling dissolution method has a pseudo phase transition point between sol and gel in the vicinity of 33° C., and below that temperature, the solution is in the form of homogeneous gel. Therefore, the solution needs to be kept at a temperature higher than or equal to the pseudo phase transition point, and preferably at a temperature higher by about 10° C. than the gel-phase transition point. However, the pseudo phase transition point varies depending on the acetic acid content, viscosity average polymerization degree, and solution concentration of cellulose acetate, and an organic solvent which is used.

The cellulose acylate film is produced from the prepared cellulose acylate solution (dope) using a solvent-casting method.

The dope is cast on a drum or a band, followed by evaporation of the solvent to form the film. Preferably, the dope to be cast is adjusted to a solid content concentration of 18 to 35%.

The surface of the drum or band is preferably mirror-finished. The casting and drying processes in the solvent-casting method are described in U.S. Pat. Nos. 2,336,310, 2,367,603, 2,492,078, 2,492,977, 2,492,978, 2,607,704, 2,739,069, and 2,739,070, and GB Patent Nos. 640731 and 736892, and Japanese Examined Patent Publication Nos. S45-4554, S49-5614, and S62-115035.

The dope is preferably cast on a drum or band having a surface temperature of 10° C. or less.

After the cast, the dope is preferably dried by applying air thereto for two seconds or more. Alternatively, the resultant film can be removed from the drum or band, followed by drying by applying thereto high-temperature air that is successively changed from 100 to 160° C. in order to evaporate away the residual solvent. This procedure is described in Japanese Examined Patent Publication No. H05-17844. According to this procedure, it is possible to reduce a time required from the casting to the removal. In order to carry out this procedure, the dope needs to become gel at the surface temperature of the drum or band when it is cast.

A film can be formed by casting two or more layers using a solvent-casting method where a plurality of prepared cellulose acylate solutions (dopes) are used. In this case, the dopes are cast on a drum or a band, followed by evaporation of the solvent to form the film. The dopes to be cast are preferably adjusted to a solid content concentration of 10 to 40%. The surface of the drum or band is preferably mirror-finished.

When a plurality of cellulose acylate solutions are cast to form two or more layers, a film may be formed by laminating layers while separately casting the solutions containing cellulose acylate through a plurality of casting nozzles which can cast a plurality of types of cellulose acylate solutions and are disposed at intervals in a progression direction of a support. Methods applicable thereto are described in, for example, Japanese Unexamined Patent Publication Nos. S61-158414, H01-122419, and H11-198285. Alternatively, a film may be obtained by casting cellulose acylate solutions through two casting nozzles. Methods applicable thereto are described in, for example, Japanese Unexamined Patent Publication Nos. S60-27562, S61-94724, S61-104813, S61-158413, and H06-134933. Alternatively, a cellulose acylate film casting method described in Japanese Unexamined Patent Publication No. S56-162617 may be used in which a flow of a high-viscosity cellulose acylate solution is enclosed in a low-viscosity cellulose acylate solution, and the high- and low-viscosity cellulose acylate solutions are simultaneously extruded.

Alternatively, two casting nozzles may be used so that a film formed on a support through a first casting nozzle is removed and a second casting is performed on the side of the film that has been in contact with the support to form a film, as in a method described in, for example, Japanese Examined Patent Publication No. S44-20235. The cellulose acylate solutions which are to be cast may be, but are not particularly limited to, the same or different cellulose acylate solutions. To cause a plurality of cellulose acylate layers to have respective functions, cellulose acylate solutions corresponding to the functions are extruded out through respective casting nozzles.

Further, in the present invention, the cellulose acylate solution may be simultaneously cast together with another solution for forming a functional layer (e.g., an adhesive layer, a dye layer, an antistatic layer, an antihalation layer, a UV-absorbing layer, a polarizing layer, etc.) to simultaneously form the functional layer and a film.

In the case of a solution for a single layer, it is necessary to extrude a high-concentration and high-viscosity cellulose acylate solution in order to obtain a desired film thickness. In such a case, however, the cellulose acylate solution is not stable, and therefore, solid contents are generated, causing defects, such as blistering and insufficient flatness. A method for solving this problem is to cast a plurality of cellulose acylate solutions through casting nozzles. This makes it possible to simultaneously extrude high-viscosity cellulose acylate solutions onto a support to form a film having good flatness and a satisfactory surface. In addition, the use of the dense cellulose acylate solution can reduce the load of drying and increase the speed of film production.

A plasticizer can be added to the cellulose acylate film in order to improve a mechanical property thereof or increase the speed of drying after casting during film production. As the plasticizer, phospholic acid ester or carboxylic acid ester is used. Examples of the phospholic acid ester include triphenyl phosphate (TPP), diphenylbiphenyl phosphate, and tricresyl phosphate (TCP). Representative examples of the carboxylic acid ester include phthalic acid esters and ctric acid esters. Examples of the phthalic acid esters include dimethyl phthalate (DMP), diethyl phthalate (DEP), dibutyl phthalate (DBP), dioctyl phthalate (DOP), diphenyl phthalate (DPP), and diethylhexyl phthalate (DEF). Examples of the citric acid esters include triethyl O-acetylcitrate (OACTE) and tributyl O-acetylcitrate (OACTB). Other examples of the carboxylic acid ester include butyl oleate, methylacetyl ricinoleate, dibutyl sebacate, and various trimellitic acid esters. Phthalic acid ester plasticizers (DMP, DEP, DBP, DOP, DPP, DEHP) are preferably used. DEP and DPP are particularly preferred.

The added amount of the plasticizer is preferably 0.1 to 25% by mass, more preferably 1 to 20% by mass, and most preferably 3 to 15% by mass, of cellulose acylate.

An anti-aging agent (e.g., an antioxidant, a peroxide-degrading agent, a radical inhibitor, a metal inactivator, an acid scavenger, amine) may be added to the cellulose acylate film. The anti-aging agent is described in Japanese Unexamined Patent Publication Nos. H03-199201, H05-197073, H05-194789, H05-271471, and H06-107854. In consideration of the effect of the anti-aging agent and its bleeding out onto film surface, the anti-aging agent is added preferably in an amount of 0.01 to 1% by mass, and more preferably 0.01 to 0.2% by mass, of the solution to be prepared (dope). Particularly preferable examples of the anti-aging agent include butylated hydroxytoluene (BHT) and tribenzylamine (TBA).

A retardation increasing agent can be used as required to adjust the retardation of the cellulose acylate film. The retardation of the film is preferably 0 to 300 nm in the thickness direction Rth(λ) and 0 to 1000 nm in the in-plane direction Re(λ). Rth(λ) and Re(λ) will be described below.

An aromatic compound having at least two aromatic rings is preferable as the retardation increasing agent, and the aromatic compound is used in an amount of 0.01 to 20 parts by mass with respect to 100 parts by mass of cellulose acylate. The aromatic compound is preferably used in an amount of 0.05 to 15 parts by mass, and more preferably 0.1 to 10 parts by mass, for 100 parts by mass of cellulose acetate. Two or more types of aromatic compounds may be used in combination.

The details thereof are described in, for example, Japanese Unexamined Patent Publication Nos. 2000-111914, 2000-275434, and 2002-236215, and International Publication WO00/065384.

(Drawing Treatment of Cellulose Acylate Film)

Drawing treatment can improve a produced cellulose acylate film in terms of uneven thickness and surface roughness, which are caused by uneven drying or drying contraction. Also, the drawing treatment is used for retardation adjustment.

The drawing treatment is not particularly limited to a width direction, and one example thereof is drawing treatment by a tenter.

More preferably, vertical drawing is carried out in a longitudinal direction of a roll, and the vertical drawing can be carried out by adjusting draw ratios between pass rolls for conveying a roll film (rotation ratios between pass rolls).

(Surface Treatment of Cellulose Acylate Film)

The cellulose acylate film is preferably subjected to surface treatment. Specific examples of the surface treatment include corona discharge treatment, glow discharge treatment, flame treatment, acid treatment, alkali treatment, and UV irradiation. As disclosed in Japanese Unexamined Patent Publication No. H07-333433, an undercoat layer is preferably provided.

From the viewpoint of securing the flatness of the film, in the above treatments, the temperature of the cellulose acylate film is kept preferably at Tg or less, specifically at 150° C. or less.

When a cellulose acylate film is adhered to a polarizing film as in the case where the anti-reflection film of the present invention is used as a protection film for a polarizing plate, from the viewpoint of adhesiveness to the polarizing film, it is particularly preferable to perform acid treatment or alkali treatment, i.e., saponification treatment, on cellulose acylate from the viewpoint of the adhesiveness between the cellulose acylate film and the polarizing film.

From the viewpoint of the adhesiveness or the like, the surface energy of the cellulose acylate film is preferably 55 mN/m or more, more preferably 60 mN/m or more to 75 mN/m or less, and can be adjusted by the above-mentioned surface treatment.

The surface energy of a solid can be obtained by a contact angle method, a wetting heat method, or an adsorption method as described in “Nure No Kiso To Ouyou (Basics and Application of Wetting)” published by Realize Corporation, Dec. 10, 1989. For the cellulose acylate film of the present invention, the contact angle method is preferably used.

Specifically, two types of solutions whose surface energy is known are dropped onto the cellulose acylate film, and a tangent line is drawn to a droplet on a film surface at an intersection of a droplet surface and the film surface, and an angle which is made by the tangent line and the film surface and includes the droplet is defined as a contact angle, and based on the contact angle, it is possible to calculate the surface energy of the film.

Hereinafter, the surface treatment will be specifically described by illustrating an alkali saponification

Preferably, alkali saponification is performed in a cycle including: immersing the film surface in an alkali solution; neutralizing it with an acid solution; rinsing it in water; and drying it.

Examples of the alkali solution include a potassium hydrate solution and a sodium hydrate solution, and their alkali concentration is preferably 0.1 mol/l to 3.0 mol/l, more preferably 0.5 mol/l to 2.0 mol/l. The temperature of the alkali solution is preferably room temperature to 90° C., more preferably 40° C. to 70° C.

From the viewpoint of productivity, it is preferable to apply an alkaline solution to the film surface, and after saponification treatment, remove alkali therefrom by rinsing in water. From the viewpoint of wettability, the solvent that is to be applied is preferably an alcohol, such as IPA, n-butanol, methanol, or ethanol, and an auxiliary agent for alkali dissolution, such as water, propylene glycol, ethylene glycol, or the like, may be preferably added.

(Hard Coat Layer)

The anti-reflection film of the present invention is provided with a hard coat layer on at least one side of a transparent support in order to confer physical strength to the film. In the present invention, in order to prevent the irregular interference pattern in the hard coat layer, the hard coat layer is applied, dried, and cured on the transparent support, and thereafter, a mixed region is generated in which a transparent resin of the support and an ionizing-radiation curable resin of the hard coat layer are mixed, so that a layer of the mixed region is formed between the transparent support and the hard coat layer. Further, a low refractive index layer is provided on the hard coat layer, and a medium refractive index layer and a high refractive index layer are preferably provided between the hard coat layer and the low refractive index layer. Thus, the anti-reflection film of the present invention is constructed.

The anti-reflection film of the present invention essentially has a flat surface in order to avoid white blurring, image blurring, and a glare phenomenon. Specifically, among characteristics representing surface roughness, the center line average roughness (Ra) is set to be 0.10 μm or less. Ra is more preferably 0.09 μm or less, and even more preferably 0.08 μm or less. In the anti-reflection film of the present invention, the surface roughness of the hard coat layer is dominant in the surface roughness of the film, and therefore, by setting the center line average roughness of the hard coat layer to be within the above-described range, the center line average roughness of the anti-reflection film can fall within the above-described range.

The anti-reflection film of the present invention preferably has a degree of transmission image sharpness of 60% or more. The transmission image sharpness degree is generally an index representing the degree of blurring of an image produced through a film, and indicating that the image viewed through the film becomes sharper and clearer as the value is increased. The transmission image sharpness degree is preferably 70% or more, more preferably 80% or more.

The transmission image sharpness degree can be measured using an optical comb having a slit width of 5 mm in an image clarity meter (ICM-2D type) manufactured by Suga Test Instruments Co., Ltd. in accordance with JIS K 7105.

In view of optical design for obtaining a film having an anti-reflection capability, the hard coat layer for use in the present invention preferably has a refractive index within the range of 1.48 to 2.00, more preferably 1.52 to 1.90, and even more preferably 1.55 to 1.80. In the present invention, at least one low refractive index layer overlies the hard coat layer. Therefore, if the refractive index is excessively lower than the above-described range, the anti-reflection capability tends to be smaller, and if the refractive index is excessively larger, the color tone of reflected light tends to become more intense.

From the viewpoint of sufficient durability and shock resistance of the film, the hard coat layer typically has a thickness of about 0.5 μm to 50 μm, preferably 1 μm to 20 μm, more preferably 2 μm to 10 μm, and most preferably 3 μm to 7 μm.

The strength of the hard coat layer is preferably H or more in a pencil hardness test in conformity with JIS K5400, more preferably 2H or more, and most preferably 3H or more.

Further, in a tabor test in conformity with JIS K5400, the abrasion loss of a test piece due to the test is preferably as small as possible.

The mixed region that is to be generated after application of the hard coat layer is affected by various conditions, such as the solid content of a coating solution for the hard coat layer, the type of a solvent, the composition of the solvent, the type of an ionizing-radiation curable compound, an additive, the type of a transparent support to which the hard coat layer is applied, the amount of a coating solution applied to the bard coat layer, drying conditions, and curing conditions. The present invention is not particularly limited to the above-described conditions, if the mixed region is generated between the transparent support and the hard coat layer to achieve the effect of suppressing the irregular interference pattern in the hard coat layer.

The mixed region layer preferably has a thickness of 0.2 to 10 μm, more preferably 0.3 to 7 μm, and even more preferably 0.5 to 5 μm. If the mixed region layer has a thickness less than the above-described range, the effect of suppressing the irregular interference pattern in the hard coat layer tends to become low, and if the above-described range is exceeded, the strength of the hard coat layer tends to be reduced. The thickness of the mixed region layer can be obtained based on a picture captured by cutting an anti-reflection film with a microtome, and observing the cross section using a scanning electron microscope (S-570, manufactured by Hitachi Ltd.) in a reflection electron mode.

The hard coat layer is preferably formed by a crosslinking reaction or a polymerization reaction of the ionizing-radiation curable compound. For example, it can be formed by applying a coating composition which contains an ionizing-radiation curable polyfunctional monomer or a polyfunctional oligomer onto the transparent support, and subjecting a polyfunctional monomer or a polyfunctional oligomer to a crosslinking reaction or a polymerization reaction.

The ionizing-radiation curable polyfunctional monomer or polyfunctional oligomer is preferably a photopolymerizable functional group, an electron beam-polymerizable functional group, or a radiation polymerizable functional group, and among them, the photopolymerizable functional group is particularly preferable.

Examples of the photopolymerizable functional group include unsaturated polymerizable functional groups, such as a (meth)acryloyl group, a vinyl group, a styryl group, and an allyl group, and among them, a (meth)acryloyl group is particularly preferable.

Specific examples of the photopolymerizable polyfunctional monomer having a photopolymerizable functional group include:

(meth)acrylic acid diesters of alkylene glycol, such as neopentylglycol acrylate, 1,6-hexanediol(meth)acrylate, propylene glycol di(meth)acrylate, and the like;

(meth)acrylic acid diesters of polyoxyalkylene glycol, such as triethylene glycol di(meth)acrylate, dipropylene glycol di(meth)acrylate, polyethylene glycol di(meth)acrylate, polypropylene glycol di(meth)acrylate, and the like;

(meth)acrylic acid diesters of polyalcohol, such as pentaerythritol di(meth)acrylate, and the like; and

(meth)acrylic acid diesters of ethylene oxide or propylene oxide adduct, such as 2,2-bis {4-(acryloxy diethoxy)phenyl } propane, 2-2-bis {4-(acryloxy polypropoxy)phenyl}propane, and the like.

Further, epoxy (meth)acrylates, urethane (meth)acrylates, and polyester (meth)acrylates are also preferably used as the photopolymerizable polyfunctional monomer.

Particularly, esters of polyalcohol and (meth)acrylic acid are preferable. Further, polyfunctional monomers having three or more (meth)acryloyl groups per molecule are preferable. Specifically, examples thereof include trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, (di)pentaerythritol triacrylate, (di)pentaerythritol pentacrylate, (di)pentaerythritol tetra(meth)acrylate, (di)pentaerythritol hexa(meth)acrylate, tripentaerythritol triacrylate, tripentaerythritol hexatriacrylate, etc. As used herein, “(meth)acrylate”, “(meth)acrylic acid”, and “(meth)acryloyl” represent “acrylate or methacrylate”, “acrylic acid or methacrylic acid”, “acryloyl or methacryloyl”, respectively.

Two or more types of polyfunctional monomers may be used in combination.

For polymerization reaction of the photopolymerizable polyfunctional monomer, a photo-initiator is preferably used. As the photo-initiator, a photo-radical polymerization initiator and a photo-cation polymerization initiator are preferable, and the photo-radical polymerization initiator is particularly preferable.

Examples of the photo-radical polymerization initiator include acetophenones, benzophenones, Michler's benzoyl benzoate, α-amyloxime ester, tetramethylthiuram monosulfide, and thioxanthones.

Examples of commercially available photo-radical polymerization initiators include KAYACURE (DETX-S, BP-100, BDMK, CTX, BMS, 2-EAQ, ABQ, CPTX, EPD, ITX, QTX, BTC, MCA, etc.) manufactured by Nippon Kayaku Co., IRGACURE (651, 184, 500, 907, 369, 1173, 2959, 4265, 4263, etc.) manufactured by Ciba Specialty Chemicals, and Esacure (KIP100F, KB1, EB3, BP, X33, KT046, KT37, KIP150, TZT) manufactured by Sartomer Company, Inc.

In particular, a photo-fragmentation-type photo-radical polymerization initiator is preferable. The photo-fragmentation-type photo-radical polymerization initiator is described in “Saishin UV Kouka Gijyutsu (Latest UV Curing Technology)”, Technical Information Institute Co., Ltd., 1991, p.159. Examples of the commercially available photo-fragmentation-type photo-radical polymerization initiator include IRGACURE (651, 184, 907) manufactured by Ciba Specialty Chemicals, and the like.

The photo-initiator is preferably used in an amount of 0.1 to 15 parts by mass, and more preferably 1 to 10 parts by mass, with respect to 100 parts by mass of the polyfunctional monomer.

In addition to the photo-initiator, a photosensitizer may be used. Specific examples of the photosensitizer include n-butylamine, triethylamine, tri-n-butylphosphine, Michler's ketone, and thioxanthone. Examples of commercially available photosensitizers include KAYACURE (DMBI, EPA) manufactured by Nippon Kayaku Co., and the like.

The photopolymerization reaction is preferably carried out by ultraviolet irradiation after application and drying of the hard coat layer.

A binder which is crosslinked or polymerized to the hard coat layer has a structure such that the main chain of the polymer is crosslinked or polymerized thereto. Examples of the polymer main chain include polyolefin (saturated hydrocarbon), polyether, polyurea, polyurethane, polyester, polyamine, polyamide, and melamine resin. A polyolefin main chain, a polyether main chain, and a polyurea main chain are preferable. The polyolefin main chain and the polyether main chain are more preferable. The polyolefin main chain is most preferable.

The polyolefin main chain is made of saturated hydrocarbon. The polyolefin main chain is obtained by, for example, an addition polymerization reaction of unsaturated polymerizable groups. The polyether main chain has repeating units linked by ether linkage (—O—). The polyether main chain is obtained by, for example, a ring-opening polymerization reaction of epoxy groups. The polyurea main chain has repeating units linked by urea linkage (—NH—CO—NH—). The polyurea main chain is obtained by, for example, a condensation polymerization reaction of an isocyanate group and an amino group. The polyurethane main chain has repeating units linked by urethane linkage (—NH—CO—O—). The polyurethane main chain is obtained by, for example, a condensation polymerization reaction of an isocyanate group and a hydroxyl group (including an N-methylol group). The polyester resin main chain has repeating units linked by ester linkage (—CO—O—). The polyester resin main chain is obtained by, for example, a condensation polymerization reaction of a carboxyl group (including an acid halide group) and a hydroxyl group (including an N-methylol group). The polyamine main chain has repeating units linked by imino linkage (—NH—). The polyamine main chain is obtained by, for example, a ring-opening polymerization reaction of ethyleneimine groups. The polyamide main chain has repeating units linked by amide linkage (—NH—CO—). The polyamide main chain is obtained by, for example, a reaction of an isocyanate group and a carboxy group (including an acid halide group). The melamine resin main chain is obtained by, for example, a condensation polymerization reaction of a triazine group (e.g., melamine) and aldehyde (e.g., formaldehyde). Note that, in case of the melamine resin, the main chain itself has a crosslinked or polymerized structure.

In order to control the refractive index of the hard coat layer, either or both a high refractive index monomer and an inorganic microparticle can be added to the binder of the hard coat layer. In addition to the effect of controlling the refractive index, the inorganic microparticle has the effect of suppressing curing shrinkage due to a crosslinking reaction. As used herein, the term “binder” includes a polymer which is generated by polymerizing the above-described polyfunctional monomer and/or the high refractive index monomer or the like after formation of the hard coat layer, and the polymer including an inorganic microparticle dispersed therein.

Examples of the high refractive index monomer include bis(4-methacryloyl thiophenyl)sulfide, vinyl naphthalene, vinyl phenylsulfide, 4-methacryloxy phenyl-4′-methoxy phenyl thioether, and the like.

Examples of the inorganic microparticle include oxides of at least one metal selected from silicon, zirconium, titanium, aluminum, indium, zinc, tin, and antimony; and also include BaSO₄, CaCO₃, talc, kaolin, and the like. The inorganic microparticle preferably has a particle diameter of 100 nm or less, more preferably 50 nm or less. By using a fine inorganic microparticle having a particle diameter of 100 nm or less, it is possible to form a hard coat layer without loss of transparency.

The inorganic microparticle preferable for the purpose of increasing the refractive index of the hard coat layer is preferably an ultrafine oxide particle of at least one metal selected from Al, Zr, Zn, Ti, In, and Sn. Specific examples thereof include ZrO₂, TiO₂, Al₂O₃, In₂O₃, ZnO, SnO₂, Sb₂O₃, and ITO. Among them, ZrO₂ is particularly preferably.

The added amount of the high refractive index monomer and the inorganic microparticle is preferably 10 to 90% by mass, more preferably 20 to 80% by mass, of the total mass of the binder. Two or more types of inorganic microparticles may be used in the hard coat layer.

The haze of the hard coat layer varies depending on a function to be conferred to the anti-reflection film.

In order to maintain the sharpness of an image, suppress surface reflectance, and provide no light scattering function, the haze value is desirably kept as low as possible. Specifically, the haze value is preferably 10% or less, more preferably 5% or less, and most preferably 2% or less.

On the other hand, in order to conferring, in addition to the function of suppressing surface reflectance, the function of utilizing scattering to cause the pattern, uneven colors, and uneven brightness of a liquid crystal panel not to stand out, or the function of utilizing scattering to increase a viewing angle, the haze value is preferably 10% to 90%, more preferably 15% to 80%, and most preferably 20% to 70%.

The anti-reflection film of the present invention is a film having considerably small or substantially no surface roughness and substantially no surface haze. Therefore, haze may be preferably provided as internal haze to the film. Therefore, the hard coat layer preferably has an internal haze, i.e., an internal scattering capability.

In order to confer the function of increasing a viewing angle, it is important to adjust the haze value, and in addition, the intensity distribution (scattered light profile) of scattered light in the hard coat layer, which is measured by a goniophotometer. For example, in the case of a liquid crystal display, the viewing angle characteristics are improved as light which is emitted from a backlight is diffused to a further extent by an anti-reflection film provided on a surface of a polarizing plate which is viewed. However, if it is excessively diffused, backward scattering is increased, leading to a problem, such as a reduction in front brightness, a degradation in image sharpness due to excessive scattering, or the like. Therefore, it is necessary to control the intensity distribution of scattered light of the hard coat layer within a suitable range. In order to achieve desired viewing characteristics, the intensity of scattered light at an emission angle of 30°, which is particularly correlated with the effect of improving the viewing angle, is preferably 0.01% to 0.2%, more preferably 0.02% to 0.15%, and most preferably 0.02% to 0.1%, with respect to the intensity of light at an emission angle of 0° of the scattered light profile.

The scattered light profile of the anti-reflection film having a hard coat layer can be measured using an Automatic Variation Angle Photometer GP-5 manufactured by Murakami Color Research Laboratory.

As a method for causing the hard coat layer to have an internal scattering capability or a desired scattering profile, it is preferable to add a binder (containing the above-mentioned inorganic particle capable of adjusting the refractive index) into a translucent particle having a refractive index different from that of the binder. A difference in refractive index between the binder and the translucent particle is preferably 0.02 to 0.20. If the difference in refractive index is within this range, a suitable optical diffusion effect is achieved, and there is substantially no possibility that the entire film is whitened due to an excessive optical diffusion effect. Note that the difference in refractive index is more preferably 0.03 to 0.15, and most preferably 0.04 to 0.13.

The combination of a binder and a translucent particle can be selected as appropriate for the purpose of adjusting the difference in refractive index.

The translucent particle preferably has a particle diameter of 0.5 μm to 5 μm. If the particle diameter is within the above-described range, the effect of optical diffusion is appropriate, the backward scattering is small, and the use efficiency of light is sufficient. In addition, fine surface roughness is achieved, and substantially no white blurring and glare phenomenon occur. Note that the particle diameter of the translucent particle is preferably 0.7 μm to 4.5 μm, and most preferably 1.0 μm to 4.0 μm.

In order for the hard coat layer to contain the translucent particle, it is necessary to adjust a thickness of the hard coat layer so as not to cause surface roughness due to the particle. Typically, a large thickness is provided to prevent a protrusion of the particle from projecting from the hard coat surface, thereby making it possible to cause the surface roughness Ra (center line average roughness) to be 0.10 μm or less.

The translucent particle may be an organic particle or an inorganic particle. The smaller the variation in the diameter of the particle, the smaller the variation in the scattering characteristics and the easier the design of the haze value. As the translucent microparticle, a plastic bead is preferable, and particularly, one that has high transparency and a difference in refractive index from the binder, which has the above-described value.

Examples of the organic particle include a polymethyl methacrylate bead (refractive index: 1.49), an acryl-styrene copolymer bead (refractive index: 1.54), a melamine bead (refractive index: 1.57), a polycarbonate bead (refractive index: 1.57), a styrene bead (refractive index: 1.60), a crosslinked polystyrene bead (refractive index: 1.61), a polyvinyl chloride bead (refractive index: 1.60), a benzoguanamine-melamine formaldehyde bead (refractive index: 1.68), and the like.

Examples of the inorganic particle include a silica bead (refractive index: 1.44), an alumina beads (refractive index: 1.63), and the like.

As the translucent particle, one that has a particle diameter of 0.5 to 5 μm may be selected and used as appropriate and as described above. Two or more types of translucent particles may be mixed and used. The translucent particle(s) may be contained in an amount of 5 to 30 parts by mass with respect to 100 parts by mass of the binder.

The above-described translucent particle tends to precipitate in the binder, and therefore, an inorganic filler, such as silica, may be added to the binder in order to prevent precipitation. Note that, as the added amount of an inorganic filler is increased, the precipitation of the translucent particle is more effectively prevented. However, the inorganic filler adversely affects the transparency of a coating film. Therefore, an inorganic filler having a particle diameter of 0.5 μm or less is preferably added to the binder in an amount of about 0.1% by mass which does not impair the transparency of the coating film.

A solvent for a coating solution which is used to form the hard coat layer forms a mixed region between the support and the hard coat layer. Therefore, in the present invention, it is necessary to select a solvent having a property of dissolving or swelling the support. This is because, if such a solvent is used as the coating solution, the hard coat layer is formed while dissolving or swelling the support immediately after application thereof, resulting in an indistinguishable interface between the support and the hard coat layer, and at the same time, formation of a layer of region where a resin component of the hard coat layer and a resin component of the support are mixed.

Further, in order to control the surface roughness of the hard coat layer (to reduce or flatten the roughness) while strengthening the hard coat layer, it is preferable to add at least one type of solvent which does not dissolve the transparent support (e.g., a triacetylcellulose support). More preferably, at least one type of solvent which dissolves the transparent support has a boiling point higher than that of at least one type of solvent which does not dissolve the transparent support. Even more preferably, the difference in temperature at boiling point between a solvent having the highest boiling point among those which dissolves the transparent support and a solvent having the highest boiling point among those which do not dissolve the transparent support is 30° C. or more, most preferably 50° C. or more.

In the case where the support is a cellulose acylate film, examples of a solvent which have a property of dissolving or swelling the support include:

ethers having three to twelve carbon atoms: specifically, dibutyl ether, dimethoxymethane, dimethoxyethane, diethoxyethane, propylene oxide, 1,4-dioxane, 1,3-dioxolane, 1,3,5-trioxane, tetrahydrofuran, anisole, phenetol, and the like;

ketones having three to twelve carbon atoms: specifically, acetone, methyl ethyl ketone, diethyl ketone, dipropyl ketone, diisobutyl ketone, cyclopentanone, cyclohexanone, methylcyclohexanone, methylcyclohexanone, and the like;

esters having three to twelve carbon atoms: specifically, ethyl formate, propyl formate, n-pentyl formate, methyl acetate, ethyl acetate, methyl propionate, ethyl propionate, n-pentyl acetate, y-butyrolactone, and the like; and

organic solvents having two or more types of functional groups: specifically, 2-methoxymethyl acetate, 2-ethoxymethyl acetate, 2-ethoxyethyl acetate, 2-ethoxyethyl propionate, 2-methoxyethanol, 2-propoxyethanol, 2-buthoxyethanol, 1,2-diacethoxy acetone, acetyl acetone, diacetone alcohol, methyl acetoacetate, ethyl acetoacetate, and the like.

These may be used singly or in combination of two or more. As a solvent which dissolves the transparent support, ketone solvents are preferable, and particularly, methyl ethyl ketone and cyclohexanone are preferable.

Examples of the solvent which does not dissolve the transparent support (preferably, triacetylcellulose) include methanol, ethanol, 1-propanol, 2-propanol, 1-butanol, 2-butanol, tert-butanol, 1-pentanol, 2-methyl-2-butanol, cyclohexanol, isobutyl acetate, methyl isobutyl ketone, 2-octanone, 2-pentanone, 2-hexanone, 2-heptanone, 3-pentanone, 3-heptanone, 4-heptanone, toluene, and the like.

These may be used singly or in combination of two or more.

The mass ratio (A/B) between the total amount (A) of the solvents which dissolve the transparent support and the total amount (B) of the solvents which do not dissolve the transparent support is preferably in the range of 10/90 to 100/10, more preferably 20/80 to 100/0, and even more preferably 30/70 to 100/0.

(Low Refractive Index Layer)

The anti-reflection film of the present invention has a low refractive index layer as the outermost layer. The low refractive index layer preferably has a refractive index of 1.20 to 1.46, more preferably 1.25 to 1.41, and most preferably 1.30 to 1.39. In terms of low reflectance, the low refractive index layer preferably satisfies the following expression (1):

(m₁/4)λ×0.7<n₁d₁<(m₁/4)λ×1.3 Expression (1):

In the above-described expression (1), m₁ is a positive odd number, n₁ is the refractive index of the low refractive index layer, and d₁ is the thickness (nm) of the low refractive index layer. Also, λ is a wavelength having a value in the range of 500 to 550 nm. Note that satisfying the expression (1) means that there is a value of m₁ (positive odd number, typically 1) which satisfies expression (1) in the above-described wavelength range.

The low refractive index layer contains, as a low refractive index binder, a fluorinated polymer, a fluorinated sol-gel material, or the like. The fluorinated polymer or sol-gel is preferably a material crosslinkable by heat or ionizing radiation, from which a low refractive index layer having a surface whose dynamic friction coefficient is 0.03 to 0. 15 is formed, and the material preferably has a contact angle with respect to water of 90 to 120°. An inorganic filler for enhancing the strength of the film can be added to the low refractive index layer for use in the present invention.

Examples of the fluorinated polymer for use in the low refractive index layer include hydrolysates and dehydrrocondensation products of perfluoroalkyl group-containing silane compounds (e.g., (heptadecafluoro-1,1,2,2-tetrahydrodecyl)triethoxysilane)), and also include a fluorinated copolymer having, as components, a fluorinated monomeric unit and a structural unit for conferring crosslinking reactivity.

Specific examples of the fluorinated monomeric unit include fluoroolefins (e.g., fluoroethylene, vinylidene fluoride, tetrafluoroethylene, hexafluoropropylene, perfluoro-2,2-dimethyl-1,3-dioxole, etc.), partially or fully fluorinated alkylester derivatives of (meth)acrylic acid (e.g., Biscoat 6FM (manufactured by Osaka Organic Chemical Industries, Ltd.), or M-2020 (manufactured by Daikin Industries, Ltd.)), and fully or partially fluorinated vinyl ethers. Perfluoroolefins are preferable, and hexafluoropropylene is particularly preferable from the viewpoint of refractive index, solubility, transparency, availability, and the like.

Examples of the structural unit for conferring the crosslinking reactivity include structural units obtained by polymerization of monomers, such as glycidyl (meth)acrylate, and glycidyl vinyl ether, which have a self crosslinkable functional group in their molecules, structural units obtained by polymerization of monomers having a carboxyl group, a hydroxyl group, an amino group, a sulfo group, or the like (e.g., (meth)acrylic acid, methylol (meth)acrylate, hydroxyalkyl (meth)acrylate, allyl acrylate, hydroxy ethyl vinyl ether, hydroxy butyl vinyl ether, maleic acid, crotonic acid, etc.), and structural units obtained by subjecting the above-described structural units to a polymer reaction to introduce a crosslinking reaction group, such as (meth)acryloyl or the like (which can be introduced, for example, in such a manner as to react acrylic acid chloride with a hydroxyl group).

In addition to the fluorinated monomeric units and the structural units for conferring crosslinking reactivity, a monomer which does not contain a fluorine atom can be copolymerized as appropriate from the viewpoint of solubility in solvent, coating transparency, etc. Examples of the monomeric units usable in combination include, but are not particularly limited to, olefins (e.g., ethylene, propylene, isoprene, vinyl chloride, vinylidene chloride, etc.), acrylate esters (e.g., methyl acrylate, methyl acrylate, ethyl acrylate, 2-ethylhexyl acrylate, etc.), methacrylate esters (e.g., methyl methacrylate, ethyl methacrylate, butyl methacrylate, ethylene glycol dimethacrylate, etc.), styrene derivatives (e.g., styrene, divinylbenzene, vinyltoluene, α-methylstyrene, etc.), vinyl ethers (e.g., methylvinyl ether, ethylvinyl ether, cyclohexyl vinyl ether, etc.), vinyl esters (e.g., vinyl acetate, vinyl propionate, vinyl cinnamate, etc.), acrylamides (e.g., N-tert-butylacrylamide, N-cyclohexylacrylamide, etc.), methacrylamides, and acrylonitrile derivatives, and the like.

The above-described polymers may be used as appropriate in combination with a curing agent as described in Japanese Unexamined Patent Publication Nos. H10-25388 and H10-147739.

A fluorinated polymer which is particularly useful in the present invention is a random copolymer of perfluoroolefin with vinyl ethers or vinyl esters. It is particularly preferable that the fluorinated polymer has a group crosslinkable by itself (e.g., a radical reactive group, such as (meth)acryloyl or the like, and a ring-opening polymerizable group, such as an epoxy group, an oxetanyl, or the like). These crosslinkable group-containing polymeric units preferably are included in an amount of 5 to 70 mol %, particularly preferably 30 to 60 mol %, with respect to all the polymeric units of the fluorinated polymer. Specific examples of preferable fluorinated polymers include those described in Japanese Unexamined Patent Publication No. 2004-45462 (paragraphs 0035 to 0047), which can be synthesized by a method as described therein.

A polysiloxane structure is preferably introduced to the fluorinated polymer of the present invention for the purpose of conferring stainproofness. Preferable examples of a method for introducing a polysiloxane structure include, but are not limited to, a method of using a silicone macro azo initiator to introduce a polysiloxane block copolymerizable component, as described in Japanese Unexamined Patent Publication Nos. HI 1-189621, H11-228631, and 2000-313709, and a method of using a silicone macromer to introduce a polysiloxane graft copolymerizable component, as described in Japanese Unexamined Patent Publication Nos. H02-251555 and H02-308806. These polysiloxane components are preferably introduced in an amount of 0.5 to 10% by mass, particularly preferably 1 to 5% by mass, of the polymer. Also, compounds as described in Japanese Unexamined Patent Publication No. 2003-329804 (paragraphs 0011 to 0045) can be preferably used in the present invention.

In order to confer stainproofness, reactive group-containing polysiloxanes (e.g., KF-100T, X-22-169AS, KF-102, X-22-3701IE, X-22-164B, X-22-5002, X-22-173B, X-22-174D, X-22-167B, and X-22-161AS (trade names, manufactured by Shin-etsu Chemical Co., Ltd.), AK-5, AK-30, and AK-32 (trade names, manufactured by TOAGOSEI CO., LTD.), SILAPLANE FM0275, and SILAPLANE FM0721 (trade names, manufactured by CHISSO CORPORATION)) are preferably added in addition to the above-described polysiloxane structures. In this case, these polysiloxanes are preferably added in an amount of 0.5 to 10% by mass, particularly preferably 1 to 5% by mass, of the total solid content of the low refractive index layer.

The low refractive index layer for use in the present invention contains hollow a silica microparticle for the purpose of achieving both a low refractive index and abrasion resistance.

The hollow silica microparticle preferably has a refractive index of 1.17 to 1.40, more preferably 1.17 to 1.35, and most preferably 1.17 to 1.30. As used herein, the refractive index indicates the refractive index of the entire particle, but does not indicate the refractive index of only outer shell silica forming the hollow silica microparticle. In this case, if the radius of an empty space within the particle is represented by a, and the radius of the outer shell of the particle is represented by b, void fraction x is calculated by the following expression (2).

x=(4πa³/3)/(4πb³/3)×100 Expression (2):

The void fraction x is preferably 10 to 60%, more preferably 20 to 60%, and most preferably 30 to 60%. If an attempt is made to cause the hollow silica microparticle to have a lower refractive index and a higher void fraction, the outer shell becomes thinner and the strength of the particle becomes lower. Therefore, a particle having a low refractive index of less than 1.17 is insufficient from the viewpoint of abrasion resistance.

Note that the refractive index of the hollow silica microparticle was measured by an Abbe refractometer (manufactured by Atago Co., Ltd.).

Methods for producing the hollow silica microparticle are described in, for example, Japanese Unexamined Patent Publication Nos. 2001-233611 and 2002-79616.

The amount of a hollow silica particle which is applied and provided is preferably 1 mg/m² to 100 mg/m², more preferably 5 mg/m² to 80 mg/m², and even more preferably 10 mg/m² to 60 mg/m². When the applied and provided amount is within the above-described range, the effects of lowering the refractive index and improving the abrasion resistance are achieved, and fine surface roughness does not occur on a surface of the low refractive index layer, unlikely leading to a deterioration in appearance, such as black density, and integrated reflectance.

The average particle diameter of the hollow silica microparticle is 5 nm or more to 200 nm or less, preferably 20 nm or more to 150 nm or less, more preferably 30 nm or more to 80 nm or less, and even more preferably 40 nm or more to 60 nm or less.

If the particle diameter of the hollow silica microparticle is within the above-described range, the proportion of the empty space is appropriate for reduction of the refractive index, so that the surface of the low refractive index layer has no deterioration of external appearance, such as blackness and integrated reflectance due to fine surface roughness.

The outer shell silica of the hollow silica microparticle may be either crystalline or amorphous. As for the size distribution, the hollow silica microparticle is preferably a monodispersion particle, but may be either a polydispersion particle or an agglomerated particle if it has a predetermined particle diameter. The most desirable shape is spherical, and no problem may arise if the shape is irregular.

The average particle diameter of the hollow silica microparticle can be obtained based on electron micrograph.

In the present invention, for the purpose of improving the abrasion resistance, other inorganic fillers can be contained together with the hollow silica microparticle.

Such an inorganic filler desirably has a low refractive index because it is contained in the low refractive index layer. Examples of the inorganic filler include magnesium fluoride and silica. Particularly, a silica microparticle without empty space is preferable from the viewpoint of refractive index, dispersion stability, and cost. The particle diameter of the silica microparticle without empty space is preferably 30 nm or more to 150 nm or less, more preferably 35 nm or more to 80 nm or less, and most preferably 40 nm or more to 60 nm or less.

Also, at least one type of silica microparticle whose average particle diameter is less than 25% of the thickness of the low refractive index layer (referred to as a “small particle size silica microparticle”) is desirably used in combination with a silica microparticle having the above-described particle diameter (referred to as a “large particle size silica microparticle”).

The small particle size silica microparticle can be present in a gap between each large particle size silica microparticle, and therefore, can contribute as a holder for the large particle size silica microparticle.

The average particle diameter of the small particle size silica microparticle is preferably 1 nm or more to 20 nm or less, more preferably 5 nm or more to 15 nm or less, and particularly preferably 10 nm or more to 15 nm or less. The use of such a silica microparticle is preferable in terms of material cost and as the effect as a holder.

The silica microparticle may be subjected to a physical surface treatment, such as a plasma discharge treatment or a corona discharge treatment, or a chemical surface treatment with a surfactant, a coupling agent, or the like to stabilize dispersion thereof in a dispersion or a coating solution or to enhance affinity or adhesion to a binder component. The use of a coupling agent is particularly preferable. As the coupling agent, an alkoxymetal compound (e.g., a titanium coupling agent, a silane coupling agent) is preferably used. Among them, the silane coupling agent is preferable, and organosilane compounds represented by general formulas (1) and (2) described below are preferable. A treatment with a silane coupling agent having an acryloyl group or a methacryloyl group is particularly effective.

The above-described coupling agent may be used as a surface treatment agent for the inorganic filler for the low refractive index layer in order to perform a surface treatment before preparing a coating solution for the low refractive index layer. Further, preferably, the coupling agent may be added as an additive to the low refractive index layer when preparing the coating solution for the low refractive index layer.

The silica microparticle is preferably dispersed in a medium before a surface treatment in order to reduce the load of the surface treatment.

In the present invention, preferably, at least one of a hydrolysate of an organosilane compound or a partial condensate thereof, i.e., a so-called sol component (hereinafter called in this manner) is contained in at least one of the hard coat layer and the low refractive index layer, more preferably in both of them, from the viewpoint of abrasion resistance.

An appropriate organosilane sol content may vary depending on a layer to which it is added. The amount of organosilane sol added to the low refractive index layer is preferably 0.1 to 50% by mass, more preferably 0.5 to 20% by mass, and particularly preferably 1 to 10% by mass, with respect to the entire solid content of the low refractive index layer.

The amount of organosilane sol used in the low refractive index layer is preferably 5 to 100% by mass, more preferably 5 to 40% by mass, even more preferably 8 to 35% by mass, and particularly preferably 10 to 30% by mass, with respect to the fluorinated polymer in the low refractive index layer from the viewpoint of the effect of use of the sol, the refractive index of the layer, and the shape and surface state of the formed layer.

The amount of organosilane sol added to the hard coat layer is preferably 0.5 to 50% by mass, more preferably 1 to 30% by mass, and particularly preferably 2 to 20% by mass, with respect to the entire solid content of the hard coat layer. The added amount thereof to the other layers is preferably 0.001 to 50% by mass, more preferably 0.01 to 20% by mass, even more preferably 0.05 to 10% by mass, and particularly preferably 0.1 to 5% by mass, with respect to the entire solid content of the layer which contains the sol (the layer to which the sol is added).

The organosilane compound used can be represented by the following general formula (1).

(R¹⁰)ₘ−Si(X)₄₋ₘ General formula (1)

In the above general formula (1), R¹⁰ represents a substituted or unsubstituted alkyl or aryl group.

“X” represents a hydrolyzable group, examples of which include alkoxy groups (preferably, alkoxy groups having one to five carbon atoms, e.g., methoxy and ethoxy groups, etc.), halogen (e.g., Cl, Br, I, etc.), and R²COO (where R² is preferably a hydrogen atom or an alkyl group having one to five carbon atoms, e.g., CH₃COO, C₂H₅COO, etc.). Alkoxy groups are preferable, and a methoxy group or an ethoxy group is particularly preferable.

“m” represents an integer of 1 to 3. When a plurality of R¹⁰s or Xs exist, the plurality of R¹⁰s or Xs may be the same or different from each other. “m” is preferably 1 or 2, and particularly preferably 1.

Examples of a substituent contained in R¹⁰ include, but are not particularly limited to, halogen (e.g., fluorine, chlorine, bromine, etc.), a hydroxyl group, a mercapto group, a carboxyl groups, an epoxy groups, alkyl groups (e.g., methyl, ethyl, i-propyl, propyl, t-butyl, etc.), aryl groups (e.g., phenyl, naphthyl, etc.), aromatic heterocyclic groups (e.g., furyl, pyrazolyl, pyridyl, etc.), alkoxy groups (e.g., methoxy, ethoxy, i-propoxy, hexyloxy, etc.), aryloxy groups (e.g., phenoxy, etc.), alkylthio groups (e.g., methylthio, ethylthio, etc.), arylthio groups (e.g., phenylthio, etc.), alkenyl groups (e.g., vinyl, 1-propenyl, etc.), acyloxy groups (e.g., acetoxy, acryloyloxy, methacryloyloxy, etc.), alkoxycarbonyl groups (e.g., methoxycarbonyl, ethoxycarbonyl, etc.), aryloxycarbonyl groups (e.g., phenoxycarbonyl, etc.), carbamoyl groups (e.g., carbamoyl, N-methylcarbamoyl, N,N-dimethylcarbamoyl, N-methyl-N-octylcarbamoyl, etc.), acylamino groups (e.g., acetylamino, benzoylamino, acrylamino, and methacrylamino, etc.), and the like. These substituents may be further substituted.

When a plurality of R¹⁰s exist, at least one of them is preferably a substituted alkyl or aryl group.

Among the organosilane compounds represented by general formula (1), organosilane compounds having a vinyl-polymerizable substituent represented by the following general formula (2) are preferable.

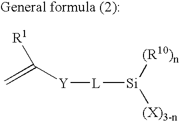

In general formula (2), R¹ represents a hydrogen atom, an alkyl group (e.g., a methyl group, an ethyl group, etc.), an alkoxy group (e.g., a methoxy group, an ethoxy group, etc.), an alkoxycarbonyl group (e.g., a methoxycarbonyl group, an ethoxycarbonyl group, etc.), a cyano group, or a halogen atom (e.g., a fluorine atom, a chlorine atom, etc.). Among them, a hydrogen atom, a methyl group, a methoxy group, a methoxycarbonyl group, a cyano group, a fluorine atom, and a chlorine atom are preferable. A hydrogen atom, a methyl group, a methoxycarbonyl group, a fluorine atom, and a chlorine atom are more preferable. A hydrogen atom and a methyl group are particularly preferable.

“Y” represents a single bond, an ester group, an amide group, an ether group, or a urea group. Among them, a single bond, an ester group, and an amide group are preferable. A single bond and an ester group are more preferable. An ester group is particularly preferable.

“L” represents a divalent linking group. Specific examples thereof include substituted or unsubstituted alkylene groups, substituted or unsubstituted arylene groups, substituted or unsubstituted alkylene groups having linking groups (e.g., ether, ester, amide, etc.) inside thereof, and substituted or unsubstituted arylene groups having linking groups inside thereof. Among them, substituted or unsubstituted alkylene groups, substituted or unsubstituted arylene groups, and alkylene groups having linking groups inside thereof are preferable. Unsubstituted alkylene groups, unsubstituted arylene groups, and alkylene groups having inside thereof linking groups formed by ether or ester are more preferable. Unsubstituted alkylene groups and alkylene groups having inside thereof linking groups formed by ether or ester are particularly preferable. Examples of the substituent include a halogen atom, a hydroxyl group, a mercapto group, a carboxyl group, an epoxy group, alkyl groups, aryl groups, and the like. These substituents may be further substituted.

“n” represents 0 or 1. When a plurality of Xs exist, the plurality of Xs may be the same or different from each other. “n” is preferably 0.

R¹⁰ is the same as defined in general formula (1), and is preferably a substituted or unsubstituted alkyl group or an unsubstituted aryl group, more preferably an unsubstituted alkyl group or an unsubstituted aryl group.

“X” is the same as defined in general formula (1), and is preferably halogen, a hydroxyl group, and an unsubstituted alkoxy group, more preferably a chlorine atom, a hydroxyl group, and an unsubstituted alkoxy group having one to six carbon atoms, even more preferably a hydroxyl group, and an alkoxy group having one to three carbon atoms, and particularly preferably a methoxy group.

As the organosilane compounds, two or more types of compounds represented by general formulas (1) and (2) may be used in combination. Specific examples of the compounds represented by general formulas (1) and (2) will be illustrated below, but the present invention is not limited to these compounds.

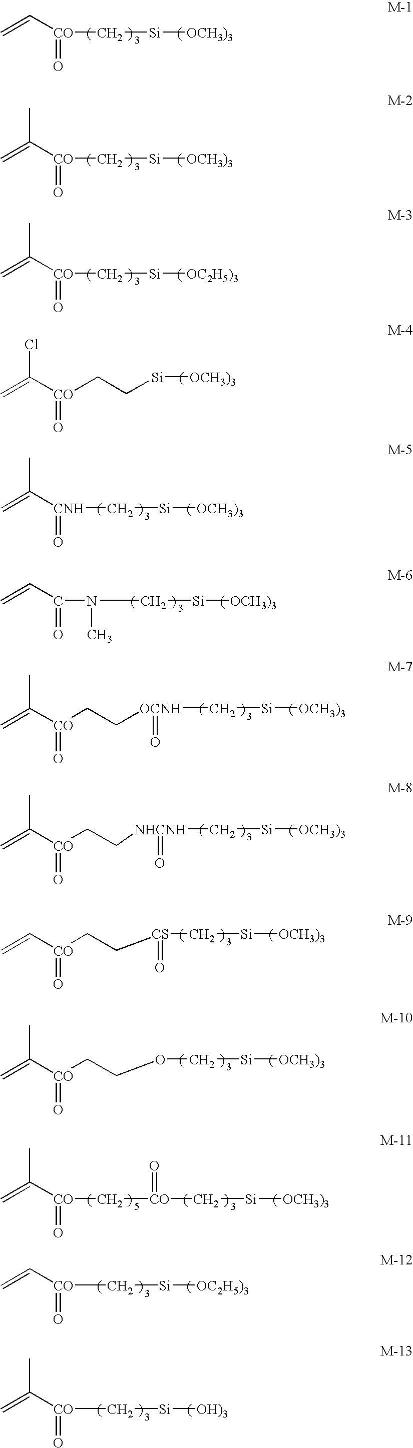

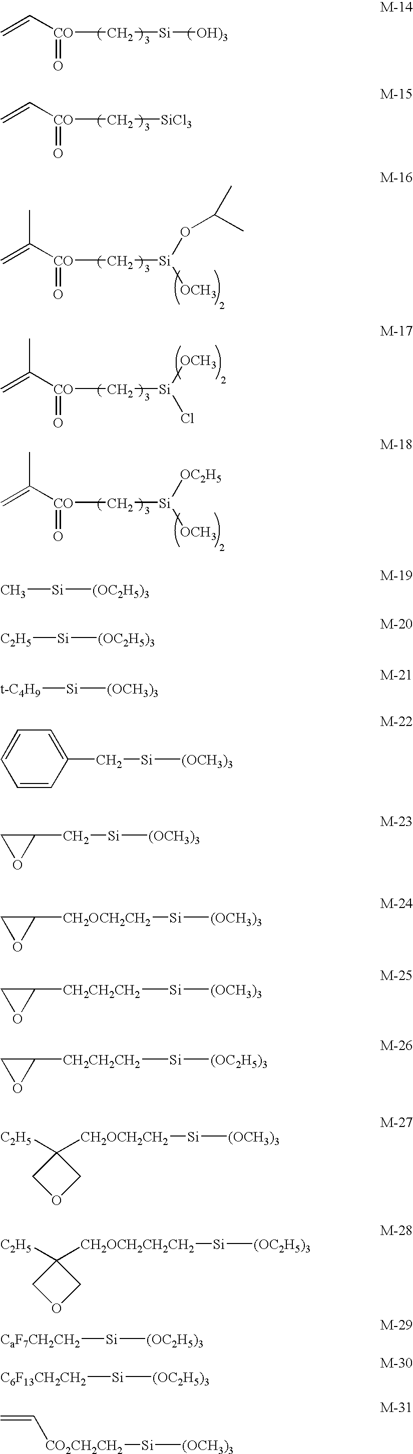

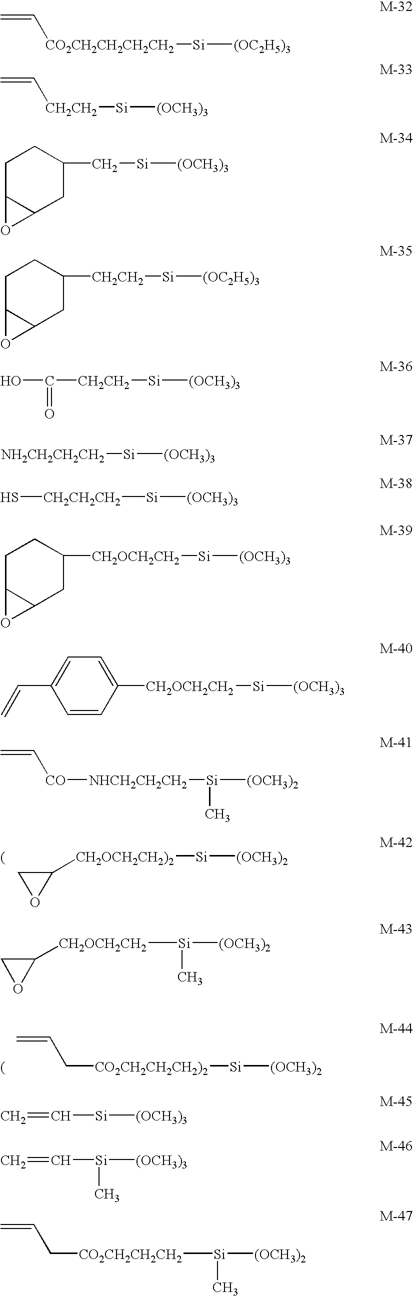

A hydrolysis/condensation reaction of organosilane may be carried out without a solvent or in a solvent, but in order to uniformly mix the component, an organic solvent is preferably used. Preferable examples of the organic solvent include alcohols, aromatic hydrocarbons, ethers, ketones, esters, and the like.

The solvent is preferably capable of dissolving organosilane and a catalyst. Further, an organic solvent is preferably used as a coating solution or a part thereof in view of the manufacturing process, and preferably does not impair the solubility or dispersibility of the fluorinated polymer or other materials when mixed with them.

Among them, examples of the alcohols include monovalent alcohols and divalent alcohols. Among them, as the monovalent alcohols, saturated aliphatic alcohols having one to eight carbon atoms are preferable. Specific examples of these alcohols include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether, ethylene glycol monoethyl ether acetate, and the like.

Specific examples of the aromatic hydrocarbons include benzene, toluene, xylene, and the like. Specific examples of the ethers include tetrahydrofurane, dioxane, and the like. Specific examples of the ketones include acetone, methyl ethyl ketone, methyl isobutyl ketone, diisobutyl ketone, and the like. Specific examples of the esters include ethyl acetate, propyl acetate, butyl acetate, propylene carbonate, and the like.

These organic solvents can be used singly or in combination of two or more.

The concentration of the solid content in the above-described reaction is, but is not specifically limited to, typically in the range of 1% to 90%, preferably 20% to 70%.

The hydrolysis/condensation reaction of organosilane is preferably carried out in the presence of a catalyst. Examples of the catalyst include: inorganic acids, such as hydrochloric acid, sulfuric acid, nitric acid, and the like; organic acids, such as oxalic acid, acetic acid, formic acid, methane sulfonic acid, toluene sulfonic acid, and the like; inorganic bases, such as sodium hydroxide, potassium hydroxide, ammonia, and the like; organic bases, such as triethylamine, pyridine, and the like; metal alkoxides, such as triisopropoxy aluminum, tetrabutoxy zirconium, and the like; metal chelate compounds containing as a central metal a metal, such as Zr, Ti, Al, or the like; and the like. Acid catalysts (inorganic acids, organic acids) and metal chelate compounds are preferable in terms of production stability or storage stability of a sol solution. As the acid catalysts, preferable inorganic acids are hydrochloric acid and sulfuric acid, and preferable organic acids are those having an acid dissociation constant (pKa value (25° C.)) of 4.5 or less in water. Hydrochloric acid, sulfuric acid, and organic acids having an acid dissociation constant of 3.0 or less in water are more preferable. Hydrochloric acid, sulfuric acid, and organic acids having an acid dissociation constant of 2.5 or less in water are even more preferable. Organic acids having an acid dissociation constant of 2.5 or less in water are still more preferable. Methane sulfonic acid, oxalic acid, phthalic acid, and malonic acid are still even more preferable. Oxalic acid is particularly prefreable.

The hydrolysis/condensation reaction is typically carried out by adding water to organosilane in an amount of 0.3 to 2 mols, preferably 0.5 to 1 mol, per mol of a hydrolyzable group in the organosilane, and by stirring the mixture at a temperature of 25 to 100° C. in the presence or absence of the above-described solvent, and preferably in the presence of the above-described solvent.

In the case where the hydrolyzable group is alkoxide and the catalyst is an organic acid, since a carboxyl or a sulfo group of the organic acid supplies protons, the added amount of water can be reduced. The added amount of water is 0 to 2 mols, preferably 0 to 1.5 mols, more preferably 0 to I mol, and particularly preferably 0 to 0.5 mols, per mol of the alkoxide group of the organosilane. When an alcohol is used as a solvent, it is also preferable to add substantially no water.

In the case where the catalyst is an inorganic acid, the amount of the catalyst used is 0.01 to 10 mol %, preferably 0.1 to 5 mol %, with respect to the amount of the hydrolyzable group. In the case where the catalyst used is an organic acid, if water is added, the optimum amount of the catalyst is 0.01 to 10 mol %, preferably 0.1 to 5 mol %, with respect to the amount of the hydrolyzable group, though the optimum amount may vary depending on the added amount of water. If substantially no water is added, the optimum amount is 1 to 500 mol %, preferably 10 to 200 mol %, more preferably 20 to 200 mol %, even more preferably 50 to 150 mol %, and particularly preferably 50 to 120 mol %, with respect to the amount of the hydrolyzable group.

The reaction is carried out by stirring at a temperature of 25 to 100° C., and an appropriate adjustment is preferably made depending on the reactivity of organosilane.

As the metal chelate compound, any compound can be appropriately used without a particular limitation, which has, as a central metal, a metal selected from Zr, Ti, and Al, and also has, as ligands, an alcohol represented by a general formula R³OH (where R³ represents an alkyl group having one to ten carbon atoms) and a compound represented by a general formula R⁴COCH₂COR⁵ (where R⁴ represents an alkyl group having one to ten carbon atoms, and R⁵ represents an alkyl group having one to ten carbon atoms or an alkoxy group having one to ten carbon atoms). If the above-described condition is satisfied, two or more types of metal chelate compounds may be used in combination. The metal chelate compound for use in the present invention is preferably selected from the group consisting of compounds represented by general formulas Zr(OR³)ₚ₁(R⁴COCHCOR⁵)ₚ₂, Ti(OR³)_{q1}(R⁴COCHCOR⁵)_{q2}, and Al(OR³)ᵣ₁(R⁴COCHCOR⁵)ᵣ₂, and has a function of promoting a condensation reaction of a hydrolysate and/or a partial condensate of the organosilane compound.

In the metal chelate compound, R³ and R⁴ may be the same or different from each other and may be alkyl groups having one to ten carbon atoms, specifically, an ethyl group, an n-propyl group, an i-propyl group, an n-butyl group, a sec-butyl group, a t-butyl group, an n-pentyl group, a phenyl group, and the like. R⁵ is an alkyl group having one to ten carbon atoms as defined above, an alkoxy group having one to ten carbon atoms (e.g., a methoxy group, an ethoxy group, an n-propoxy group, an i-propoxy group, an n-butoxy group, a sec-butoxy group, t-butoxy, or the like), or the like. In the metal chelate compound, p1, p2, q1, q2, r1, and r2 represent integers which are determined in a manner that satisfies p1+p2=4, q1+q2=4, and r1+r2=3.

Specific examples of these metal chelate compounds include: zirconium chelate compounds, such as tri-n-butoxyethyl acetoacetate zirconium, di-n-butoxybis(ethylacetoacetate)zirconium, n-butoxytris(ethylacetoacetate)zirconium, tetrakis(n-propylacetoacetate)zirconium, tetrakis(acetylacetoacetate)zirconium, tetrakis(ethylacetoacetate)zirconium, and the like; titanium chelate compounds, such as diisopropoxy bis(ethylacetoacetate)titanium, diisopropoxy bis(acetylacetate)titanium, diisopropoxy bis(acetylacetone)titanium, and the like; aluminum chelate compounds, such as diisopropoxy ethylacetoacetate aluminum, diisopropoxy acetylacetonato aluminum, isopropoxybis(ethylacetoacetate)aluminum, isopropoxybis(acetylacetonato)aluminum, tris(ethylacetoacetate)aluminum, tris(acetylacetonato)aluminum, monoacetylacetonato bis(ethylacetoacetate)aluminum, and the like; and the like.

Among these metal chelate compounds, tri-n-butoxyethyl acetoacetate zirconium, diisopropoxybis(acetylacetonato)titanium, diisopropoxy ethylacetoacetate aluminum, and tris(ethylacetoacetate)aluminum are preferable. These metal chelate compounds can be used singly or in combination of two or more. Also, partial hydrolysates of these metal chelate compounds can be used.

The metal chelate compound of the present invention is preferably used in an amount of 0.01 to 50% by mass, more preferably 0.1 to 50% by mass, and even more preferably 0.5 to 10% by mass, with respect to organosilane from the viewpoint of the rate of condensation reaction and the strength of a film when coating.

In the coating solution used to form the low refractive index layer according to the present invention, either a single solvent or a mixture of solvents may be used. In the case where a mixture solvents is used, the proportion of a solvent(s) having a boiling point of 100° C. or less is preferably 50% to 100%, more preferably 80% to 100%, even more preferably 90% to 100%, and still even more preferably 100%. When the proportion of the solvent(s) having a boiling point of 100° C. or less is within the above-described range, the rate of drying is fast, the surface state of the coating is satisfactory, and the thickness of the coating is uniform, resulting in satisfactory optical characteristics, such as reflectance and the like.

Examples of the solvent having a boiling point of 100° C. or less include: hydrocarbons, such as hexane (boiling point: 68.7° C.; hereinafter, ° C. will be omitted), heptane (98.4), cyclohexane (80.7), benzene(80.1), and the like; halogenated hydrocarbons, such as dichloromethane (39.8), chloroform (61.2), carbon tetrachloride (76.8), 1,2-dichloroethane (83.5), trichloroethylene (87.2), and the like; ethers, such as diethyl ether (34.6), diisopropyl ether (68.5), dipropyl ether (90.5), tetrahydrofuran (66), and the like; esters, such as ethyl formate (54.2), methyl acetate (57.8), ethyl acetate (77.1), isopropyl acetate (89), and the like; ketones, such as acetone (56.1), 2-butanone (=methyl ethyl ketone, 79.6), and the like; alcohols, such as methanol (64.5), ethanol (78.3), 2-propanol (82.4), 1-propanol (97.2), and the like; cyano compounds, such as acetonitrile (81.6), propionitrile (97.4), and the like; carbon disulfide (46.2); and the like. Among them, ketones and esters are preferable, and ketones are particularly preferable. Among ketones, 2-butanone is particularly preferable.

Examples of the solvent having a boiling point of 100° C. or more include octane (125.7), toluene (110.6), xylene (138), tetrachloroethylene (121.2), chlorobenzene (131. 7), dioxane (101. 3), dibutyl ether (142.4), isobutyl acetate (118), cyclohexanone (155.7), 2-methyl-4-pentanone (=MIBK, 115.9), 1-butanol (117.7), N,N-dimethylformamide (153), N,N-dimethylacetamide (166), dimethyl sulfoxide (189), and the like. Cyclohexanone and 2-methyl-4-pentanone are preferable.

By diluting the low refractive index layer components with a solvent having the above-described composition, a coating solution for the low refractive index layer is prepared. The concentration of the coating solution is preferably adjusted as appropriate in consideration of the viscosity of the coating solution, the specific gravity of the layer material, or the like, and is preferably 0.1 to 20% by mass, more preferably 1 to 10% by mass.

(High Refractive Index Layer)

The anti-reflection film of the present invention is provided with a high refractive index layer and a medium refractive index layer on the hard coat layer, thereby making it possible to enhance the anti-reflection capability. The refractive indexes of the high refractive index layer and medium refractive index layer for use in the present invention are preferably 1.55 to 2.40. Hereinafter, the high refractive index layer and the medium refractive index layer may be collectively referred to as high refractive index layers. As used herein, the terms “high”, “medium”, and “low” in relation to the high refractive index layer, the medium refractive index layer, and the low refractive index layer, represent a relative relationship in magnitude of refractive index between the layers. Also, in relation to the transparent support, the refractive index preferably satisfies the following relationships: the transparent support>the low refractive index layer; and the high refractive index layer>the transparent support.

The high refractive index layer for use in the present invention preferably contains an inorganic microparticle which contains titanium dioxide as a major component and at least one element selected from cobalt, aluminum, and zirconium. The major component means a component whose amount (% by mass) is the greatest of the components constituting the particle.

In the present invention, the inorganic microparticle having titanium dioxide as a major component preferably has a refractive index of 1.90 to 2.80, more preferably 2.10 to 2.80, and most preferably 2.20 to 2.80.

The inorganic microparticle having titanium dioxide as a major component preferably has a mass average diameter of primary particle of 1 to 200 nm, more preferably 1 to 150 nm, even more preferably 1 to 100 nm, and particularly preferably 1 to 80 nm.

The particle diameter of the inorganic microparticle can be measured by a light scattering method or electron micrograph. The specific surface area of the inorganic microparticle is preferably 10 to 400 m²/g, more preferably 20 to 200 m²/g, and most preferably 30 to 150 m²/g.

The crystal structure of the inorganic microparticle having titanium dioxide as a major component preferably has a rutile, rutile/anatase mixed crystal, anatase, or amorphous structure as a major component. The rutile structure is preferable. The major component means a component whose amount (% by mass) is the greatest of the components constituting the particle.

The inorganic microparticle having titanium dioxide as a major component contains at least one element selected from Co (cobalt), Al (aluminum), and Zr (zirconium), whereby it is possible to suppress the photo-catalytic activity of the titanium dioxide, making it possible to improve the weatherability of the high refractive index layer for use in the present invention.

A particularly preferable element is Co (cobalt). Two or more elements may be preferably used in combination.

The content of Co (cobalt), Al (aluminum) or Zr (zirconium) with respect to the content of Ti (titanium) is each preferably 0.05 to 30% by mass, more preferably 0.1 to 10% by mass, even more preferably 0.2 to 7% by mass, particularly preferably 0.3 to 5% by mass, and most preferably 0.5 to 3% by mass.

Although Co (cobalt), Al (aluminum) and Zr (zirconium) can exist at least either inside or on the surface of the inorganic microparticle having titanium dioxide as a major component, they preferably exist inside the inorganic microparticle having titanium dioxide as a major component, and most preferably they exist both inside and on the surface.

There are various methods for causing Co (cobalt), Al (aluminum), and Zr (zirconium) inside the inorganic microparticle having titanium dioxide as a major component (for example, by doping). Such methods are described in, for example, Yasushi Aoki, “Ion Chyunyu Hou (Ion-implanting method”, Surface Science, 1998, Vol. 18, No. 5, pp. 262-268, Japanese Unexamined Patent Publication No. H11-263620, Japanese National Phase PCT Laid-Open Publication No. H11-512336, European Patent No. 335773, and Japanese Unexamined Patent Publication No. H05-330825.

A method for introducing Co (cobalt), Al (aluminum), and Zr (zirconium) during a particle formation process of the inorganic microparticle having titanium dioxide as a major component is particularly preferable (see, for example, Japanese National Phase PCT Laid-Open Publication No. H11-512336, European Patent No. 335773, and Japanese Unexamined Patent Publication No. H05-330825).

In addition, Co (cobalt), Al (aluminum), and Zr (zirconium) are preferably present as oxide.

Other elements can be further contained in the inorganic microparticle having titanium dioxide as a major component, depending on the purpose. The other elements may be contained as impurities. Examples of the other elements include Sn, Sb, Cu, Fe, Mn, Pb, Cd, As, Cr, Hg, Zn, Mg, Si, P, and S.

The inorganic microparticle having titanium dioxide as a major component for use in the present invention may be subjected to a surface treatment. The surface treatment is carried out using an inorganic compound or an organic compound. Examples of the inorganic compound for use in the surface treatment include cobalt-containing inorganic compounds (CoO₂, Co₂O₃, Co₃O₄, etc.), aluminum-containing inorganic compounds (Al₂O₃, Al(OH)₃, etc.), zirconium-containing inorganic compounds (ZrO₂, Zr(OH)₄, etc.), silicon-containing inorganic compounds (SiO₂, etc.), iron-containing inorganic compounds (Fe₂O₃, etc.), and the like.

Cobalt-containing inorganic compounds, aluminum-containing inorganic compounds, and zirconium-containing inorganic compounds are preferable. Cobalt-containing inorganic compounds, Al(OH)₃, and Zr(OH)₄ are most preferable.

Examples of organic compounds for use in the surface treatment include silane coupling agents and titanate coupling agents. Among them, the silane coupling agents are most preferable, and examples thereof include the silane coupling agents represented by general formula (1) or (2).

The content of the silane coupling agent is preferably 1 to 90% by mass, more preferably 2 to 80% by mass, and particularly preferably 5 to 50% by mass, with respect to the entire solid content of the high refractive index layer.

Examples of the titanate coupling agent include metalalkoxide, such as tetramethoxytitanium, tetraethoxytitanium, tetraisopropoxytitanium, and the like; Plain-Act (KR-TTS, KR-46B, KR-55, KR-41B, etc., manufactured by Ajinomoto Co., Inc.); and the like.

As other organic compounds for use in the surface treatment, for example, organic compounds having polyol, alkanolamine, or other anionic groups are preferable, and organic compounds having carboxyl, sulfonate, or phosphate groups are particularly preferable.

Stearic acid, lauric acid, oleic acid, linolic acid, and linoleic acid can be preferably used.

Further, the organic compound for use in the surface treatment preferably has a crosslinkable or polymerizable functional group. Examples of the crosslinkable or polymerizable functional group include, such as unsaturated ethylene groups capable of an addition reaction or a polymerization reaction with a radical species (e.g., a (meth)acryloyl group, an allyl group, a styryl group, a vinyloxy group, etc.), polymerizable cation groups (e.g., an epoxy group, an oxatanyl group, a vinyloxy group, etc.), polycondensation reaction groups (e.g., a hydrolyzable silyl group, an N-methylol group, etc.). Groups having an unsaturated ethylene group are preferable.

Two or more of the above-described organic compounds can be used in combination for the surface treatment. It is particularly preferable to additionally use an aluminum-containing inorganic compound and a zirconium-containing inorganic compound.

The inorganic microparticle containing titanium dioxide as a major component for use in the present invention may be subjected to the surface treatment to have a core/shell structure as described in Japanese Unexamined Patent Publication No. 2001-166104.

The shape of the inorganic microparticle having titanium dioxide as a major component and contained in the high refractive index layer may be preferably a rice-grain-like shape, a spherical shape, a cube-like shape, a spindle-like shape, or an amorphous shape. An amorphous shape and a spindle-like shape are particularly preferable.

(Dispersing Agent)

For the purpose of dispersion of the inorganic microparticle having titanium dioxide as a major component for use in the high refractive index layer of the present invention, a dispersing agent can be used.

For the purpose of dispersion of the inorganic microparticle having titanium dioxide as a major component for use in the present invention, a dispersing agent having an anionic group is particularly preferably used.

As the anionic group, a group having an acidic proton, such as a carboxyl group, a sulfonate group (and a sulfo group), a phosphate group (and a phosphono group), a sulfonamide group, or the like, or a base thereof is effective. Particularly, a carboxyl group, a sulfonate group, a phosphate group, and bases thereof are preferable. A carboxyl group and a phosphate group are particularly preferable. The number of anionic groups contained per molecule of the dispersing agent may be one or more.

For the purpose of further improving the dispersibility of the inorganic microparticle, a plurality of anionic groups may be contained. The number of anionic groups is preferably two or more in average, more preferably five or more, and particularly preferably ten or more. Also, a plurality of types of anionic groups may be contained per molecule of the dispersing agent.

The dispersing agent may preferably further contain a crosslinkable or polymerizable functional group. Examples of the crosslinkable or polymerizable functional group include unsaturated ethylene groups capable of an addition reaction or a polymerization reaction with a radical species (e.g., a (meth)acryloyl group, an allyl group, a styryl group, a vinyloxy group, etc.), cation polymerizable groups (e.g., an epoxy group, an oxatanyl group, a vinyloxy group, etc.), polycondensation reaction groups (e.g., a hydrolyzable silyl group, an N-methylol group, etc.), and the like. Functional groups having unsaturated ethylene groups are preferable.

A dispersing agent which is preferably used for the dispersion of the inorganic microparticle having titanium dioxide as a major component for use in the high refractive index layer of the present invention is one which has an anionic group and a crosslinkable or polymerizable functional group, the crosslinkable or polymerizable functional group being present on a side chain.

The mass average molecular weight (Mw) of the dispersing agent having an anionic group and a crosslinkable or polymerizable functional group which is on a side chain is preferably, but is not particularly limited to, 1000 or more. The mass average molecular weight (Mw) of the dispersing agent is more preferably 2000 to 1000000, more preferably 5000 to 200000, and particularly preferably 10000 to 100000.

As the anionic group, groups having an acidic proton, such as a carboxyl group, a sulfonate group (sulfo), a phosphate group (phosphono), a sulfonamide group, and the like, or bases thereof are effective. Particularly, a carboxyl group, a sulfonate group, a phosphate group, and bases thereof are preferable. A carboxyl group and a phosphate group are particularly preferable. The average number of anionic groups contained per molecule of the dispersing agent is preferably two or more, more preferably five or more, and particularly preferably 10 or more. A plurality of types of anionic groups may be contained per molecule of the dispersing agent.

In the dispersing agent having an anionic group and a crosslinkable or polymerizable functional group which is present on a side chain, the anionic group is present on a side chain or a terminal. The anionic group can be introduced into a side chain by synthesis utilizing a polymer reaction, such as a method of polymerizing an anionic group-containing monomer (e.g., (meth)acrylic acid , maleic acid, partially esterified maleic acid, itaconic acid, crotonic acid, 2-carboxyethyl(meth)acrylate, 2-sulfoethyl(meth)acrylate, phosphate mono-2-(meth)acryloyl oxyethylester, etc.); a method of react an acid anhydride with a polymer having a hydroxyl group, an amino group, or the like; or the like.

In the dispersing agent having an anionic group on a side chains, the content of an anionic group-containing repeating unit falls within the range of 10⁻⁴ to 100 mol %, preferably 1 to 50 mol %, and particularly preferably 5 to 20 mol %, with respect to all repeating units.

On the other hand, an anionic group can be introduced into a terminal by synthesis using, for example, a method of carrying out a polymerization reaction in the presence of an anionic group-containing chain transfer agent (e.g., thioglycolic acid, etc.); a method of carrying out a polymerization reaction using an anionic group-containing polymerization initiator (e.g., V-501 manufactured by Wako Pure Chemical Industries, Ltd.); or the like.

A dispersing agent which is particularly preferred is a dispersing agent having an anionic group on a side chain.

Examples of the crosslinkable or polymerizable functional group include unsaturated ethylene groups capable of an addition reaction or a polymerization reaction with a radical species (e.g., a (meth)acryloyl group, an allyl group, a styryl group, a vinyloxy group, etc.), cation polymerizable groups (e.g., an epoxy group, an oxatanyl group, a vinyloxy group, etc.), polycondensation reaction groups (e.g., a hydrolyzable silyl group, an N-methylol group, etc.), and the like. Functional groups having unsaturated ethylene groups are preferable.

The average number of crosslinkable or polymerizable functional groups contained per molecule of the dispersing agent is preferably two or more, more preferably five or more, and particularly preferably 10 or more. A plurality of types of crosslinkable or polymerizable functional groups may be contained per molecule of the dispersing agent.

Examples of a repeating unit having an unsaturated ethylene group on a side chain in the dispersing agent preferably used in the present invention, include repeating units of poly-1,2-butadiene and poly-1,2-isoprene structures, or repeating units of (meth)acrylic acid esters or amides, and these repeating units to which a specific residue (an R group of —COOR or —CONHR) is linked. Examples of the specific residue (R group) include —(CH₂)ₙ—CR₁═CR₂R₃, —(CH₂O )ₙ—CH₂CR₁═CR₂R₃, —(CH₂CH₂O)ₙ—CH₂CR₁═CR₂R₃, —(CH₂)ₙ—NH—CO—O—CH₂CR₁═CR₂R₃, —(CH₂)ₙ—O—CO—CR₁═CR₂R₃, and —(CH₂CH₂O)₂-X (where R₁ to R₃ are each a hydrogen atom, a halogen atom, or an alkyl, allyl, alkoxy, or allyloxy group having one to twenty carbon atoms; R₁ and R₂ or R₃ may be linked with each other to form a ring; n is an integer of 1 to 10; and X is a dicyclopentadienyl residue). Specific examples of the ester residues include —CH₂CH═CH₂, —CH₂CH₂O—CH₂CH═CH₂, —CH₂CH₂OCOCH═CH₂, —CH₂CH₂OCOC(CH₃)═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂, and CH₂CH₂O-X (where X is a dicyclopentadienyl residue). Specific examples of the amide residues include —CH₂CH═CH₂, —CH₂CH₂-Y (where Y is 1-cyclohexenyl residue), CH₂CH₂—OCO—CH═CH₂, and —CH₂CH₂—OCO—C(CH₃)═CH₂.

The above-described dispersing agent having an unsaturated ethylene group is cured by, for example, addition of a free radical (a polymerization initiating radical or a propagating radical during polymerization of a polymerizable compound) to the unsaturated linking group to perform addition polymerization either directly between molecules or via a polymerized chain of a polymerizable compound and thereby to form a crosslink between the molecules. Alternatively, the dispersing agent is cured when atoms (e.g., a hydrogen atom on a carbon atom adjacent to the unsaturated linking group) is pulled off from molecules by a free radical to form polymer radicals, which are linked with each other to form a crosslink between the molecules.

A crosslinkable or polymerizable functional group can be introduced into a side chain by synthesis using a method of performing dehydrochlorination after copolymerization of a crosslinkable or polymerizable functional group-containing monomer (e.g., furyl(meth)acrylate, glycidyl(meth)acrylate, trialkoxy silyl propyl methacrylate, etc.), copolymerization of butadiene or isoprene, or copolymerization of a vinyl monomer having a 3-chloropropionate ester site; a method of performing a polymer reaction to incorporate the crosslinkable or polymerizable functional group (e.g., a polymer reaction of an epoxy group-containing vinyl monomer to a carboxyl group-containing polymer); and the like, as described in Japanese Unexamined Patent Publication No. H03-249653, and the like.

A unit contained in the crosslinkable or polymerizable functional group may constitute all repeating units other than an anionic group-containing repeating unit, and are preferably contained in an amount of 5 to 50 mol %, particularly preferably 5 to 30 mol %, with respect to all crosslinked or repeating units.

The dispersing agent preferable in the present invention may be a copolymer of monomers having a crosslinkable or polymerizable functional group and an anionic groups, and in addition, other monomers. A copolymerization component is selected in view of various factors, such as dispersion stability, compatibility with other monomer components, the strength of a formed coating, and the like, though is not particularly limited. Preferable examples thereof include methyl(meth)acrylate, n-butyl(meth)acrylate, t-butyl(meth)acrylate, cyclohexyl(meth)acrylate, styrene, and the like.

The form of the dispersing agent preferable to the present invention is preferably, but is not limited to, a block copolymer or a random copolymer, and particularly preferably a random copolymer in view of cost and ease of synthesis.

Specific examples of the dispersing agent preferable to the present invention are illustrated below, but the dispersing agent for use in the present invention is not limited thereto. Note that these examples are random polymers unless otherwise specified.

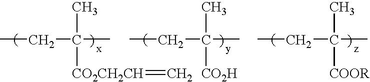

| | x | y | z | R | Mw |
|---|---|---|---|---|---|
| P-(1) | 80 | 20 | 0 | — | 10,000 |
| P-(2) | 80 | 20 | 0 | — | 110,000 |
| P-(3) | 80 | 20 | 0 | — | 10,000 |
| P-(4) | 90 | 10 | 0 | — | 40,000 |
| P-(5) | 50 | 50 | 0 | — | 40,000 |
| P-(6) | 30 | 20 | 50 | CH₂CH₂CH₃ | 30,000 |
| P-(7) | 20 | 30 | 50 | CH₂CH₂CH₂CH₃ | 50,000 |
| P-(8) | 70 | 20 | 10 | CH(CH₃)₃ | 60,000 |
| P-(9) | 70 | 20 | 10 | 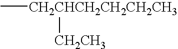 | 150,000 |
| P-(10) | 40 | 30 | 30 | 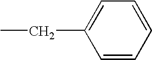 | 15,000 |

x/y/z indicate molar ratios.

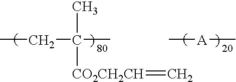

| | A | Mw |
|---|---|---|
| P-(11) | 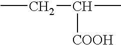 | 20,000 |
| P-(12) | 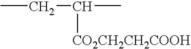 | 30,000 |
| P-(13) | 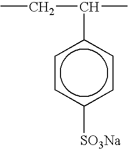 | 100,000 |
| P-(14) | 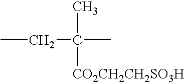 | 20,000 |
| P-(15) | 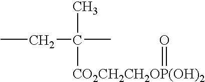 | 50,000 |
| P-(16) | 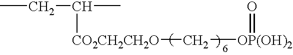 | 15,000 |

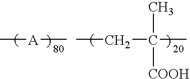

| | A | Mw |
|---|---|---|
| P-(17) | 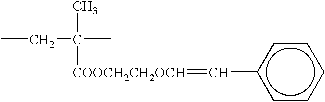 | 20,000 |
| P-(18) | 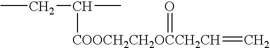 | 25,000 |
| P-(19) | 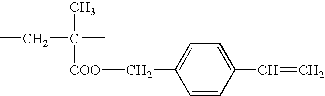 | 18,000 |
| P-(20) | 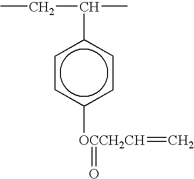 | 20,000 |
| P-(21) | 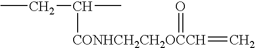 | 35,000 |

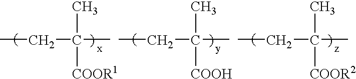

| | R¹ | R² | x | y | z | Mw |
|---|---|---|---|---|---|---|
| P-(22) | 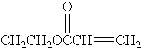 | C₄H₉(n) | 10 | 10 | 80 | 25,000 |
| P-(23) | 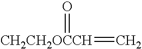 | C₄H₉(t) | 10 | 10 | 80 | 25,000 |
| P-(24) | 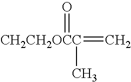 | C₄H₉(n) | 10 | 10 | 80 | 500,000 |
| P-(25) | 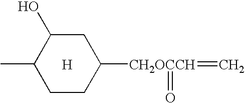 | C₄H₉(n) | 10 | 10 | 80 | 23,000 |
| P-(26) | 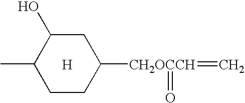 | C₄H₉(n) | 80 | 10 | 10 | 30,000 |
| P-(27) | 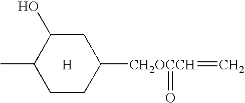 | C₄H₉(n) | 50 | 20 | 30 | 30,000 |
| P-(28) | 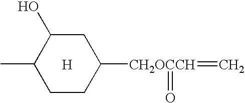 | C₄H₉(t) | 10 | 10 | 80 | 20,000 |
| P-(29) | 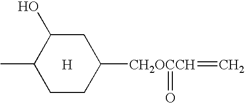 | CH₂CH₂OH | 50 | 10 | 40 | 20,000 |
| P-(30) | 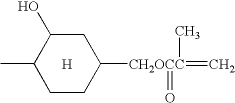 | C₄H₉(n) | 10 | 10 | 80 | 25,000 |

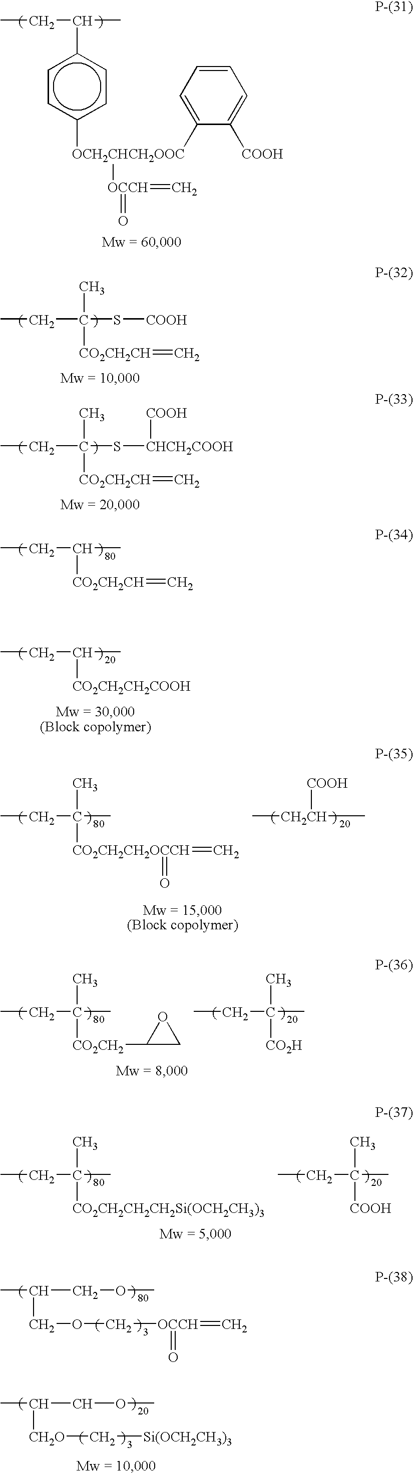

The amount of the dispersing agent used is preferably in the range of 1 to 50% by mass, more preferably in the range of 5 to 30% by mass, and most preferably 5 to 20% by mass, with respect to the inorganic microparticle having titanium dioxide as a major component. Two or more types of dispersing agents may be used in combination.

(High Refractive Index Layer and Formation Method Thereof)

The organic microparticle having titanium dioxide as a major component for use in the high refractive index layer is used in the form of dispersion during formation of the high refractive index layer. The inorganic microparticle is dispersed in a dispersive medium in the presence ofthe dispersing agent.

As the dispersive medium, a liquid having a boiling point of 60 to 170° C. is preferably used. Examples of the dispersive medium include water, alcohols (e.g., methanol, ethanol, isopropanol, butanol, benzyl alcohol), ketones (e.g., acetone, methyl ethyl ketone, methyl isobutyl ketone, cyclohexanone), esters (e.g., methyl acetate, ethyl acetate, propyl acetate, butyl acetate, methyl formate, ethyl formate, propyl formate, butyl formate), aliphatic hydrocarbons (e.g., hexane, cyclohexane), halogenated hydrocarbons (e.g., methylene chloride, chloroform, carbon tetrachloride), aromatic hydrocarbons (e.g., benzene, toluene, xylene), amides (e.g., dimethylformamide, dimethylacetamide, n-methylpyrrolidone), ethers (e.g., dimethylether , dioxane, tetrahydrofuran), and ether alcohols (e.g., 1-methoxy-2-propanol). Toluene, xylene, methyl ethyl ketone, methyl isobutyl ketone, cyclohexanone, and butanol are preferable.

Particularly preferable dispersive media are methyl ethyl ketone, methyl isobutyl ketone, and cyclohexanone.

The inorganic microparticle is dispersed using a disperser. Examples of the disperser include a sand grinder mill (e.g., a bead mill with pin), a high-speed impeller mill, a pebble mill, a roller mill, an attritor, and a colloid mill. A sand grinder mill and a high-speed impeller mill are particularly preferable. A preliminary dispersion treatment may be carried out. Examples of a disperser for use in the preliminary dispersion treatment include a ball mill, a three-roller mill, a kneader, and an extruder.

The inorganic microparticle is preferably as small as possible in the dispersive medium. The mass average diameter thereof is 1 to 200 nm, preferably 5 to 150 nm, more preferably 10 to 100 nm, and particularly preferably 10 to 80 nm.

By causing the inorganic microparticle to be as small as 200 nm or less, it is possible to form a high refractive index layer without loss of transparency.

The high refractive index layer for use in the present invention is preferably formed by adding a binder (e.g., the ionizing-radiation curable polyfunctional monomer or polyfunctional oligomer which is illustrated in the above description of the hard coat layer), a photo-initiator, a sensitizer, a coat solvent, and the like to a dispersing liquid which is obtained by dispersing the inorganic microparticle in a dispersive medium as described above, to obtain a coat composition for forming the high refractive index layer, applying the coat composition for forming the high refractive index layer onto the hard coat layer, and curing the coat composition due to a crosslinking reaction or a polymerization reaction of the ionizing-radiation curable compound (e.g, a polyfunctional monomer, a polyfunctional oligomer, etc.). Specific examples of the binder, the photo-initiator, the sensitizer, and the coat solvent include the compounds illustrated in the above description of the hard coat layer.

Further, the binder for the high refractive index layer is preferably subjected to a crosslinking reaction or a polymerization reaction with the dispersing agent simultaneously with or after application of the high refractive index layer.

In the thus-obtained binder for the high refractive index layer, for example, the dispersing agent and the ionizing-radiation curable polyfunctional monomer or polyfunctional oligomer are subjected to a crosslinking or polymerization reaction, so that an anionic group of the dispersing agent is incorporated into the binder. Further, in the binder for the high refractive index layer, the anionic group has a function of keeping the dispersed state of the inorganic microparticle, and a crosslinked or polymerized structure confers coating formation capability to the binder, so that the physical strength, chemical resistance, and weatherability of the high refractive index layer containing the inorganic microparticle are improved.

The inorganic microparticle has the effect of controlling the refractive index of the high refractive index layer and a function of suppressing curing shrinkage.

In the high refractive index layer, the inorganic microparticle is preferably dispersed as finely as possible, and has a mass average diameter of 1 to 200 nm. The mass average diameter of the inorganic microparticle in the high refractive index layer is preferably 5 to 150 nm, more preferably 10 to 100 nm, and most preferably 10 to 80 nm.

By causing the inorganic microparticle to be as small as 200 nm or less, it is possible to form a high refractive index layer without loss of transparency.

The inorganic microparticle content of the high refractive index layer is preferably 10 to 90% by mass, more preferably 15 to 80% by mass, and particularly preferably 15 to 75% by mass, with respect to the mass of the high refractive index layer. Two or more types of inorganic microparticles may be used in combination in the high refractive index layer.

Since the low refractive index layer overlies the high refractive index layer, the high refractive index layer preferably has a refractive index higher than the refractive index of the transparent support.

A binder is preferably used for the high refractive index layer, which can be obtained by a crosslinking or polymerization reaction of an ionizing-radiation curable compound having an aromatic ring; an ionizing-radiation curable compound having a halogenated atom other than fluorine (e.g., Br, I, Cl, etc.); an ionizing-radiation curable compound having atoms such as S, N, P, or the like; or the like.

The refractive index of the high refractive index layer is preferably 1.55 to 2.40, more preferably 1.60 to 2.20, even more preferably 1.65 to 2.10, and most preferably 1.80 to 2.00.

For example, in the case where three layers, i.e., the medium refractive index layer, the high refractive index layer, and the low refractive index layer, are provided in this order above the hard coat layer, the refractive index of the medium refractive index layer is preferably 1.55 to 1.80, the refractive index of the high refractive index layer is preferably 1.80 to 2.40, and the refractive index of the low refractive index layer is preferably 1.20 to 1.46.

In addition to the above-described components (the inorganic microparticle, the polymerization initiator, the photosensitizer etc.), the high refractive index layer can contain other additives, such as a resin, a surfactant, an antistatic agent, a coupling agent, a thickener, an anti-coloring agent, a coloring agent (a pigment, a dye), a defoaming agent, a leveling agent, a flame retardant, an ultraviolet absorbing agent, an infrared absorbing agent, an adhesion promoter, a polymerization-inhibitor, an antioxidant, a surface modifier, a conductive metal microparticle, and the like.

The thickness of the high refractive index layer can be designed as appropriate, depending on the purpose. When the high refractive index layer is used as an optical interference layer, which will be described below, the thickness is preferably 30 to 200 nm, more preferably 50 to 170 nm, and particularly preferably 60 to 150 nm.

(Other Layers of Anti-Reflection Film)

In order to produce an anti-reflection film having superior anti-reflection performance, it is preferable to provide a medium refractive index layer having a refractive index of between the refractive indexes of the high refractive index layer and the transparent support.

The medium refractive index layer is preferably produced in a manner similar to that described above about the high refractive index layer of the present invention, and the refractive index thereof can be adjusted by controlling the content of an inorganic microparticle in the coating thereof.

The anti-reflection film may be provided with other layers in addition to those described above. For example, an adhesion layer, a shield layer, a stainproof layer, a slip layer, or an antistatic layer may be provided. The shield layer is provided in order to shield against electromagnetic wave and infrared radiation.

The anti-reflection film in the invention can be formed according to the following methods, but the invention is not limited thereto.

### [Preparation of Coating Solution]

In the first place, a coating solution containing the components for forming each layer is prepared. At that time, by suppressing the volatile content of the solvent to the least, the increase of the moisture content in the coating solution can be restrained. The moisture content in the coating solution is preferably 5% or less, more preferably 2% or less. The volatile content of the solvent can be suppressed by heightening the sealing property at the time of stirring after putting the components into a tank, and by minimizing the contact area of the solution with air during the operation of moving the solution. Further, a means of lowering the moisture content of the coating solution during, or before and after coating may be provided.

It is preferred that a coating solution for forming a hard coat layer and the like should be subjected to filtration capable of removing almost all (it means 90% or more) the foreign matters corresponding to the dry thickness (from 50 to 120 nm or so) of the layer directly formed on the hard coat layer (a low refractive index layer, a medium refractive index layer, etc.). Since a light transmitting particle for conferring light diffusibility is the same or higher than the layer thickness of a low refractive index layer and a medium refractive index layer, it is preferred to perform the filtration to an intermediate solution that contains all the components exclusive of light transmitting particles. When such a fine filter capable of removing foreign matters having fine particle sizes is not available, it is preferred to perform filtration capable of removing almost all the foreign matters corresponding to at least the wet thickness (from 1 to 10 μm or so) of the layer directly formed thereon. By such a means, the point defect of the layer directly formed thereon can be reduced.

### [Coating and Drying]

In the next place, the coating solution for forming a layer directly coated on a support, such as a hard coat layer, is coated on a transparent support by a coating method, e.g., a dip coating method, an air-knife coating method, a curtain coating method, a roller coating method, a wire bar coating method, a gravure coating method, a microgravure coating method, or an extrusion coating method (see U.S. Pat. No. 2,681,294), and the coated layer is heated and dried. The coated layer is then cured by at least any means of light irradiation and heating, whereby a hard coat layer is formed.

If necessary, the hard coat layer may consist of a plurality of layers.

A coating layer for forming a low refractive index layer is then coated on the hard coat layer in the same manner, the solvent is dried, and the coated layer is then cured by at least any means of light irradiation and heating, whereby a low refractive index layer is formed. Thus, an anti-reflection film of the invention is obtained.

In forming a hard coat layer, it is preferred to coat the above coating solution in a wet coating thickness of from 6 to 30 μm directly on a substrate film or via other layer. As the coating method, reverse coating by a microgravure coating system is preferred.

In forming a low refractive index layer, a medium refractive index layer or a high refractive index layer, it is preferred to coat a coating solution in a wet coating thickness of from 1 to 10 μm directly on a hard coat layer or via other layer, a wet coating thickness is more preferably from 2 to 5 μm.

A hard coat layer and a low refractive index layer are, after being coated directly on a substrate film or via other layer, transferred as a web to a heated zone for drying a solvent. The temperature in the drying zone is preferably from 25 to 140° C., and it is preferred that the temperature of the former half in the drying zone is relatively low temperature and that of the latter half is relatively high temperature. However, the temperature is preferably not higher than the temperature at which the volatilization of the components other than the solvent contained in the coating composition of each layer begins. For instance, some of commercially available radical generators used in combination with UV-curable resins volatilize in hot air of 120° C. by several ten % or so within several minutes, and the volatilization of monofunctional or bifunctional acrylate monomers advances in hot air of 100° C. In such cases, the drying temperature is preferably not higher than the temperature at which the volatilization of the components other than the solvent contained in the coating composition of each layer begins, as described above.

Further, it is preferred for preventing uneven drying that the flowing rate of drying air after the coating composition of each layer has been coated on a substrate film is in the range of from 0.1 to 2 m/sec while the concentration of solids content of the coating composition is from 1 to 50%.

After coating the coating composition of each layer on a substrate film, it is preferred to make the difference in temperature in the drying zone between the substrate film and the conveying roller that is in contact with the opposite surface of the coated side of the substrate film from 0° C. to 20° C. to prevent uneven drying due to irregular heat transfer on a conveying roll.

For restraining the irregular interference pattern of a hard coat layer, it is necessary to form a mixed region of a support and the hard coat layer. A support and a hard coat layer do not mix sufficiently if drying speed is too rapid, while productivity lowers if drying speed is too slow. The flowing rate of drying air is specifically preferably from 0.1 to 10 m/sec, more preferably from 0.3 to 8 m/sec, and still more preferably from 0.5 to 5 m/sec.

The curing means of a hard coat layer and a low refractive index layer in the invention, and a medium refractive index layer and a high refractive index layer that are formed according to necessity, is described below.

A hard coat layer and a low refractive index layer in the invention, and a medium refractive index layer and a high refractive index layer that are formed according to necessity, are cured as a web by at least any means of irradiation with ionizing radiation and heating by passing through a zone for curing a coated layer after passing through a drying zone of a solvent. For example, when ultraviolet rays are used for curing, it is preferred to cure each layer by the quantity of irradiation of from 10 to 1,000 mJ/cm² with a UV lamp. At that time, the distribution of irradiation quantity in the transverse direction of the web including up to both ends is preferably distribution of from 50 to 100% of the maximum irradiation quantity at the central part, more preferably distribution of from 80 to 100%. In the invention, ionizing radiation is used in the meaning ordinarily used, which means radiations that cause excitation and ionization when passing in a material, i.e., corpuscular rays and electromagnetic waves that are merely called radiations, specifically α-rays, β-rays, γ-rays, high energy particles, neutrons, electron beams, and beams of lights (ultraviolet rays and visible rays) are exemplified. Especially preferred ionizing radiations in the invention are ultraviolet rays and visible rays.

The oxygen concentration in curing time is preferably 15% by volume or less, more preferably 1% by volume or less, and still more preferably 0.3% by volume or less. If the oxygen concentration in curing exceeds 15% by volume, deactivation of radical due to oxygen becomes conspicuous for the reason that the layer thickness of each layer in the invention after solvent-drying is as thin as from 0.1 μm to several ten μm or so (the surface area per volume is great), as a result the problems arise such that the scratch resistance, specifically described later, of a layer after curing is fatally damaged, the surface of an upper layer coated partially swells or dissolves to cause interfacial mixture, whereby reflection characteristics are deteriorated.

For controlling the oxygen concentration in curing time as above, it is preferred to reduce oxygen concentration by nitrogen purge.

When the curing rate (100—residual rate of functional groups) of a hard coat layer is a certain value less than 100%, if a low refractive index layer is provided on the hard coat layer and cured by at least any means of irradiation with ionizing radiation and heating, if the curing rate of the lower hard coat layer is higher than the curing rate of the time when the low refractive index layer is not provided, the adhesion between the hard coat layer and the low refractive index layer is improved and preferred.

(Polarizing Plate)

The polarizing plate of the present invention comprises a polarizing film and two protection films provided on opposite sides thereof.

As one of the protection films, the anti-reflection film of the present invention can be used. The other protection film may be a typical cellulose acetate film or, preferably, a cellulose acetate film which is produced by the above-described solution film formation method and is drawn at a draw ratio of 10 to 100% in a width direction in the form of a roll film.

Further, in the polarizing plate of the present invention, the other protection film (not the anti-reflection film) is preferably an optical compensation film which has an optically anisotropic layer made of a liquid crystalline compound.

Examples of the polarizing film include an iodine polarizing film, a dye polarizing film using a dichroic dye, and a polyene polarizing film. The iodine polarizing film and the dye polarizing film are generally produced using a polyvinyl alcohol film.

Slow axes of the transparent support of the anti-reflection film and the cellulose acetate film and a transmission axis of the polarizing film are disposed to be substantially parallel to each other.

The moisture permeability of the protection film is important for the productivity of the polarizing plate. The polarizing film and the protection films are attached together with a water-based adhesive, and a solvent of the adhesive is dried by diffusing through the protection films. The higher the moisture permeability of the protection films, the faster the solvent dries, i.e., the higher the productivity. However, if it becomes excessively high, the polarizing ability is decreased because moisture enters the polarizing films, depending on an environment (high humidity) where the liquid crystal display device is used.

The moisture permeability of the protection films is determined by the thickness, free volume, hydrophilicity/hydrophobicity, or the like of the transparent support and the polymer film (and the polymerizable liquid crystalline compound).

When the optical diffusion film and the anti-reflection film of the present invention are used as protection films of a polarizing plate, the moisture permeability is preferably 100 to 1000 g/m²·24 hrs, and more preferably 300 to 700 g/m²·24 hrs.

In film production, the thickness of the transparent support can be adjusted by a lip flux and a line speed, or drawing and compression. The moisture permeability varies depending on a main material used, and therefore, can be adjusted within a desirable range by adjusting the thickness.

In film production, the free volume of the transparent support can be adjusted by a drying temperature and a time. Also in this case, the moisture permeability varies depending on a main material used, and therefore, can be adjusted within a desirable range by adjusting the free volume.

The hydrophilicity/hydrophobicity of the transparent support can be adjusted by an additive. The moisture permeability can be increased by adding a hydrophilic additive to the free volume, and conversely, can be reduced by adding a hydrophobic additive.

By controlling the moisture permeabilities independently, a polarizing plate with optical compensation ability can be produced with low cost and high productivity.

(Optical Compensation Film)

The liquid crystalline compound used in the optically anisotropic layer of the optical compensation film of the present invention may be a rod-like liquid crystal or a discotic liquid crystal, which may be a high molecular weight liquid crystal or a low molecular weight liquid crystal, or may also be a low molecular weight liquid crystal which is crosslinked and no longer exhibits a liquid crystal property. A most preferably liquid crystalline compound is the discotic liquid crystal.

Preferable examples of the rod-like liquid crystal are described in Japanese Unexamined Patent Publication No. 2000-304932.

Examples of the discotic liquid crystal include a benzene derivative described in the research report by C. Destrade et al., Mol. Cryst., Vol. 71, p. 111 (1981), a truxene derivative described in the research reports by C. Destrade et al., Mol. Cryst., Vol. 122, p. 141 (1985), and Physics Lett. A., Vol. 78, p. 82 (1990), a cyclohexane derivative described in the research report by B. Kohne et al., Angew. Chem., Vol. 96, p. 70 (1984), an aza-crown-based and phenyl acetylene-based macrocycle described in the research reports by J. M. Lehn et al., J. Chem. Commun., p. 1794 (1985), and J. Zhang et al., J. Am. Chem. Soc., Vol. 116, p. 2655 (1994), and the like.

The discotic liquid crystal generally has a structure in which these derivatives are disposed as mother nuclei of the molecular center, and a straight-chain alkyl group or alkoxyl group, a substituted benzoyloxy group, or the like is radially substituted, thereby exhibiting a liquid crystal property. Note that the present invention is not limited to the above description, and any liquid crystal compound whose molecule itself has a negative uniaxial property and to which a fixed alignment can be conferred.

In the present invention, the compound having a discotic structural unit in the optically anisotropic layer does not need to be a discotic compound in the final form which is taken in the optically anisotropic layer. For example, the above-described low molecular discotic liquid crystal which has a group which becomes reactive due to heat, light, or the like, and is eventually polymerized or crosslinked due to heat, light, or the like to have a high molecular weight and lose a liquid crystal property, is included. A preferable example of the discotic liquid crystal is described in Japanese Unexamined Patent Publication No. H08-50206.

It is preferable that the optically anisotropic layer of the present invention is a layer made of a compound having a discotic structural unit, and a disc surface of the discotic structural unit inclines toward a transparent support surface (i.e., a protection film surface), and an angle made by the discotic surface of the discotic structural unit and the transparent support surface (i.e., the protection film surface) varies in a depth direction of the optically anisotropic layer.

The angle of the discotic structural unit (angle of inclination) generally increases or decreases in the depth direction of the optically anisotropic layer with an increase in a distance from a bottom of the optically anisotropic layer. The angle of inclination preferably increases with an increase in the distance. Example of a change in the angle of inclination include a continuous increase, a continuous decrease, an intermittent increase, an intermittent decrease, a change including a continuous increase and a continuous decrease, an intermittent change including an increase and a decrease, and the like. The intermittent change includes a region where the angle of inclination does not vary partway in the depth direction. The angle of inclination preferably increases or decreases as a whole even if there is a region having no change. The angle of inclination preferably increases as a whole, and particularly preferably varies continuously.

The optically anisotropic layer is generally obtained by applying on an alignment film a solution which contains a discotic compound and other compounds dissolved in a solvent, drying the solution, and heating the resultant coating to a temperature of forming a discotic nematic phase, and thereafter, cooling the coating while maintaining an alignment state thereof (discotic nematic phase). Alternatively, the optically anisotropic layer can be obtained by applying on an alignment film a solution which includes a discotic compound and other compounds (e.g., a polymerizable monomer, a photo-initiator) dissolved in a solvent, drying the solution, heating the resultant coating to a temperature of forming a discotic nematic phase, performing polymerization (e.g., by irradiation with UV light or the like), and cooling the coating. The discotic liquid crystalline compound for use in the present invention preferably has a discotic nematic liquid crystal phase-solid phase transition temperature of 70 to 300° C., particularly preferably 70 to 170° C.

Generally, the angle of inclination of the discotic unit on the support side can be adjusted by selecting the discotic compound or a material for the alignment film, or selecting a rubbing treatment method. The angle of inclination of the discotic unit on the surface side (air side) can be generally adjusted by selecting the discotic compound or other compounds which are used with the discotic compound (e.g., a plasticizer, a surfactant, a polymerizable monomer, and a polymer). Further, the degree of a change in the angle of inclination can also be adjusted by the above-described selection.

As the above-described plasticizer, surfactant, and polymerizable monomer, any compounds which are compatible with the discotic compound and can change the angle of inclination of the discotic liquid crystalline compound or does not inhibit alignment, can be used. Among them, polymerizable monomers (e.g., compounds having a vinyl group, a vinyloxy group, an acryloyl group, and a methacryloyl group) are preferable. The above-described compounds are preferably used in an amount of 1 to 50% by mass (preferably 5 to 30% by mass) with respect to the discotic compound. Preferable examples of the polymerizable monomer include multifunctional acrylates. The number of functional groups thereof is preferably three or more, more preferably four or more. A hexafunctional monomer is most preferable. A preferable example of the hexafunctional monomer is dipentaerythritol hexaacrylate. Multifunctional monomers having different numbers of functional groups can be mixed and used.

As the above-described polymers, any polymers which are compatible with the discotic compound and can change the angle of inclination of the discotic liquid crystalline compound, can be used. Examples of the polymer include cellulose esters. Preferable examples of the cellulose ester include cellulose acetate, cellulose acetate propionate, hydroxy propyl cellulose, and cellulose acetate butyrate. The above-described polymer is generally used in an amount of 0.1 to 10% by mass (preferably 0.1 to 8% by mass, particularly 0.1 to 5% by mass) with respect to the discotic compound so as not to prevent the alignment of the liquid crystal discotic compound.

In the present invention, the optically anisotropic layer includes a discotic liquid crystal formed on an alignment film provided on a protection film (e.g., cellulose acetate film) or the like, and the alignment film is preferably a film which is made of a cross-linked polymer and has been subjected to a rubbing treatment.

(Alignment Film)

The alignment film for use in the present invention, which is provided to adjust the alignment of the liquid crystalline compound of the optically anisotropic layer, is preferably a layer made of two types of cross-linked polymers. At least one of the two types of polymers is preferably either a self-crosslinkable polymer or a polymer which can be crosslinked using a crosslinking agent. The alignment film can be formed by reacting polymers having a functional group or polymers to which a functional group is introduced with each other using light, heat, a change in pH, or the like, or by using a crosslinking agent which is a highly reactive compound to introduce a linking group derived from the crosslinking agent into the polymers and thereby to crosslink the polymers.

Such a crosslink is typically caused by applying a coating solution containing the above-described polymer or a mixture of the polymer and a crosslinking agent onto the transparent support, followed by heating or the like. However, the crosslinking process may be performed at any stage between application of the alignment film on the support and formation of a final polarizing plate as long as a final product can secure durability. When the optically anisotropic layer formed on the alignment film is made of a discotic compound, crosslinking is preferably sufficiently carried out after the discotic compound is aligned in consideration of the alignment of the compound. Specifically, a coating solution containing polymers and a crosslinking agent which can crosslinks the polymers is applied on the support; the resultant structure is heated and dried (a crosslink is generally obtained, though if the heating temperature is low, a crosslink further proceeds when the compound is heated to the discotic nematic phase formation temperature); a rubbing treatment is carried out to form an alignment film; onto the alignment film, a coating solution containing a compound having a disc-like structural unit is applied; the resultant structure is heated to the discotic nematic phase formation temperature; and the resultant structure is cooled to form an optically anisotropic layer.

A polymer used in the alignment film of the present invention can be either a self-crosslinkable polymer or a polymer which is crosslinked using a crosslinking agent. There are also some polymers which are self-crosslinkable polymer and are crosslinked using a crosslinking agent. Examples of the polymer include polymers, such as polymethyl metacrylate, acrylic acid/methacrylic acid copolymer, styrene/maleinimide copolymer, polyvinyl alcohol and denatured polyvinyl alcohol, poly(N-methylolacrylamide), styrene/vinyltoluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, carboxymethylcellulose, polyethylene, polypropylene, polycarbonate, gelatin, and the like; and compounds, such as a silane coupling agent, and the like. Preferable examples of the polymer include water-soluble polymers, such as poly(N-methylolacrylamide), carboxymethylcellulose, gelatin, polyvinyl alcohol, denatured polyvinyl alcohol, and the like. Gelatin, polyvinyl alcohol and denatured polyvinyl alcohol are more preferable. Polyvinyl alcohol and denatured polyvinyl alcohol are particularly preferable.

Among the above-described polymers, polyvinyl alcohol or denatured polyvinyl alcohol is preferable, and most preferably, a polyvinyl alcohol and a denatured polyvinyl alcohol which having different polymerization degrees are used in combination.

For example, polyvinyl alcohols having a saponification degree of 70 to 100% are used. Generally, polyvinyl alcohols having a saponification degree of 80 to 100% are used. More preferably, polyvinyl alcohols having a saponification degree of 85 to 95% are used. The polymer preferably has a polymerization degree of 100 to 3000. Examples of the denatured polyvinyl alcohol include polyvinyl alcohols denatured by copolymerization (for example, COONa, Si(OX)₄, N(CH₃)₃.Cl, C₉H₁₉COO, SO₃, Na, C₁₂H₂₅, or the like is introduced as a denaturing group), those denatured by chain transfer (for example, COONa, SH, C₁₂H_{25,} or the like is introduced as a denaturing group), and those denatured by block polymerization (for example, COOH, CONH₂, COOR, C₆H₅, or the like is introduced as a denaturing group). Among them, non-denatured or denatured polyvinyl alcohols having a saponification degree of 80 to 100% are preferable, and non-denatured or denatured alkylthio polyvinyl alcohols having a saponification degree of 85 to 95% are more preferable.

A method for synthesizing denatured polyvinyl alcohol, measurement of a visible absorption spectrum, a method for determining an introduction ratio, and the like, are described in detail in Japanese Unexamined Patent Publication No. H08-338913.

Specific examples of a crosslinking agent used together with the above-described polymer, such as polyvinyl alcohols, include those indicated below, which are preferably used in combination with the above-described water-soluble polymers, particularly polyvinyl alcohols and denatured polyvinyl alcohols (including the above-described specific denatured products). The examples of the crosslinking agent include aldehydes (e.g., formaldehyde, glyoxal, and glutaraldehyde), N-methylol compounds (e.g., dimethylol urea, and methyloldimethylhydantoin), dioxane derivatives (e.g., 2,3-dihydroxydioxane), compounds which function when a carboxylic group thereof is activated (e.g., carbenium, 2-naphthalenesulfonate, 1,1-bispyrrolidino-1-chloropyridinium, and 1-morpholinocarbonyl-3-(sulfonatoaminomethyl)), active vinyl compounds (e.g., 1,3,5-triacryloyl-hexahydro-s-triazine, bis-(vinylsulfone)methane, and N,N′-methylenebis-[β-(vinylsulfonyl)propionamide]), active halogen compounds (e.g., 2,4-dichloro-6-hydroxy-S-triazine), isooxazoles, dialdehyde starch, and the like. These may be used singly or in combination. In consideration of productivity, high-reactive aldehydes are preferable, and among them, glutaraldehyde is particularly preferable.

The crosslinking agent is not particularly limited, and a larger added amount thereof tends to lead to better moisture resistance. However, if the agent is added in an amount of 50% by mass or more with respect to the polymer, the alignment capability of the alignment film is reduced, and therefore, the added amount is preferably 0.1 to 20% by mass, more preferably 0.5 to 15% by mass. In this case, the alignment film may contain some amount of an unreacted crosslinking agent after a crosslinking reaction is ended. The amount of such an unreacted crosslinking agent in the alignment film is preferably 1.0% by mass or less, particularly preferably 0.5% or less. If the alignment film contains the crosslinking agent in an amount of more than 1.0% by mass, sufficient durability is not obtained. Accordingly, if the crosslinking agent is used for a liquid crystal display device, reticulation may occur after having been used for a long time or left in an atmosphere having high temperature and high humidity.

The alignment film for use in the present invention can be formed by applying a coating solution containing the above-described polymer and crosslinking agent which are materials for forming the alignment film, onto the transparent support, followed by heating and drying (crosslinking), and a rubbing treatment. As described above, a crosslinking reaction may be carried out at any time after application of the coating solution. When a water-soluble polymer, such as the above-described polyvinyl alcohol or the like, is used as a material for forming the alignment film, a mixed solvent of water and an organic solvent, such as methanol or the like, which has a defoaming effect, is preferably used as the coating solution. The mass ratio of water to methanol is typically 0:100 to 99:1, preferably 0:100 to 91:9. Consequently, generation of foam is suppressed, and a defect on the alignment film and a surface of the optically anisotropic layer are significantly decreased. Examples of the coating method include a spin coating method, a dip coating method, a curtain coating method, an extrusion coating method, a bar coating method, and an E-type coating method. The E-type coating method is particularly preferable. The thickness of the film is preferably 0.1 to 10 μm.

The heating and drying can be carried out at 20° C. to 110° C. To ensure crosslink to a sufficient extent, the temperature is preferably 60° C. to 100° C., particularly preferably 80° C. to 100° C. A time required for drying is 1 minute to 36 hours, preferably 5 minutes to 30 minutes. pH is preferably set to be a value optimal for the crosslinking agent used. If glutaraldehyde is used as the crosslinking agent, the pH is preferably 4.5 to 5.5, particularly preferably 5.

The alignment film is provided on the transparent support directly or via an undercoating layer capable of tightly attach the transparent support to the alignment film. The undercoating layer is not particularly limited as long as it can enhance the attachment of the combination of the transparent support and the alignment film.

After the polymer layer is cross-linked as described above, the alignment film is subjected to surface rubbing treatment. The alignment film has a function to determine an alignment direction of a discotic liquid crystalline compound provided thereon.

The above-described rubbing treatment can be carried out by utilizing a treatment method which is widely employed in a liquid crystal alignment process for LCDs. Specifically, it is possible to use a method of rubbing a surface of the alignment film with paper, gauze, felt, rubber, nylon, polyester fiber, or the like along a predetermined direction, to achieve alignment. Generally, it is carried out by rubbing several times using cloth on which fibers having the same length and thickness are averagely provided.

(Transparent Support to be Coated with Optically Anisotropic Layer)

The transparent support on which the optically anisotropic layer is provided is preferably a cellulose acetate film, and may be optically uniaxial or biaxial.

The transparent support on which the optically anisotropic layer is coated, itself plays an optically important role, and therefore, Re(λ) of the transparent support is preferably adjusted to 0 to 200 nm, and Rth(λ) thereof is preferably adjusted to 70 to 400 nm.

When two optically anisotropic cellulose acetate films are used in a liquid crystal display device, Rth(λ) of the films is preferably 70 to 250 nm.

When one optically anisotropic cellulose acetate film is used in a liquid crystal display device, Rth(λ) of the film is preferably 150 to 400 nm.

Herein, Re(λ) and Rth(λ) represent in-plane retardation and width direction retardation, respectively, at a wavelength of λ. Re(λ) is measured with light having a wavelength of λ nm applied in a direction normal to the film by KOBRA-21ADH (manufactured by Oji Test Instruments). Rth(λ) is calculated by KOBRA-21ADH based on retardation values measured in three directions: Re(λ); a retardation value measured with light having a wavelength of λ nm applied in a direction inclined by +40° from the direction normal to the film surface where an in-plane slow axis (determined by KOBRA-21ADH) is the axis of inclination (axis of rotation); and a retardation value measured with light having a wavelength of λ nm applied in a direction inclined by −40° from the direction normal to the film surface where an in-plane slow axis (determined by KOBRA-21ADH) is the axis of inclination (axis of rotation). As the wavelength of λ, a value within the range of 450 to 750 nm is typically used. A value of 589.3 nm is herein used. As an assumed value of the average refractive index, values described in “Polymer Handbook” (JOHN WILEY & SONS, INC.), and a catalog of various optical films can be used. If the average refractive index value is unknown, it can be measured by an Abbe refractometer. Exemplary values of the average refractive indexes of major optical films are as follow: cellulose acylate (1.48), cycloolefin polymer (1.52), polycarbonate (1.59), polymethylmethacrylate (1.49), and polystyrene (1.59). Assumed values of the average refractive indexes and a film thickness are inputted to KOBRA 21 ADH to obtain nx, ny, and nz.

(Liquid Crystal Display Device)

The anti-reflection film and the polarizing plate of the present invention can be advantageously used in an image display device, such as a liquid crystal display device or the like, and are preferably used as an outermost layer of the display device.

The liquid crystal display device has a liquid crystal cell and two polarizing plates provided on opposite sides of the cell. The liquid crystal cell supports liquid crystal between two electrode substrates. Further, an optically anisotropic layer may be disposed between the liquid crystal cell and one of the polarizing plates, or between the liquid crystal cell and each of the polarizing plates (in this case, a total of two optically anisotropic layers are provided).

The liquid crystal cell is preferably of TN mode, VA mode, OCB mode, IPS mode, or ECB mode.

In a liquid crystal cell of TN mode, rod-like liquid crystalline molecules are substantially horizontally aligned in the absence of an applied voltage, and further, are oriented at an angle of 60 to 120° in a twisted manner.

The liquid crystal cell of TN mode is most widely used in color TFT liquid crystal display devices, and is described in a number of publications.

In a liquid crystal cell of VA mode, rod-like liquid crystalline molecules are substantially vertically aligned in the absence of an applied voltage.

The liquid crystal cell of VA mode include: (1) a liquid crystal cell of VA mode in a narrow sense (described in Japanese Unexamined Patent Publication No. H02-176625), in which the rod-like liquid crystal molecules are substantially vertically aligned in the absence of an applied voltage, and substantially horizontally aligned in the presence of an applied voltage; (2) a liquid crystal cell (of MVA mode) in which the VA mode is modified to be of a multi-domain type so as to enlarge a viewing angle (described in SID97, Digest of Tech. Papers (proceedings), 28(1997), 845); (3) a liquid crystal cell of a mode (n-ASM mode) in which rod-like liquid crystalline molecules are substantially vertically aligned in the absence of an applied voltage, and are substantially aligned in twisted multi-domain alignment in the presence of an applied voltage (described in Proceedings 58-59 (1998), Liquid crystal forum of Japan; and (4) a liquid crystal cell of SURVIVAL mode (presented at LCD international 98).

The liquid crystal cell of OCB mode is a liquid crystal cell of bend alignment mode in which rod-like liquid crystalline molecules are substantially reversely (symmetrically) aligned in upper and lower portions of the liquid crystal cell, and is disclosed in U.S. Pat. Nos. 4,583,825 and 5,410,422. Since the rod-like liquid crystal molecules are symmetrically aligned in the upper and lower portions, and therefore, the liquid crystal cell of bend alignment mode has a self-optical compensatory function. Therefore, this liquid crystal mode is called OCB (Optically Compensatory Bend) liquid crystal mode. The liquid crystal display device of bend alignment mode has an advantage of quick response speed.

The liquid crystal cell of IPS mode has a scheme in which switching is carried out by applying horizontal electric field to nematic liquid crystal, and is described in detail in Proc. IDRC (Asia Display '95), pp. 577-580 and pp. 707-710.

In a liquid crystal cell of ECB mode, rod-like liquid crystalline molecules are substantially horizontally aligned in the absence of an applied voltage. The ECB mode is one of the liquid crystal display modes which have the simplest structure, and is described in detail in, for example, Japanese Unexamined Patent Publication No. H05-203946.

### EXAMPLES

The present invention will be specifically described in the following examples. The present invention is not limited thereto.

(Preparation of Hard Coat Layer Coating Solution A)

The following ingredients were placed into a mixing tank and stirred to prepare a hard coat layer coating solution A.

(Composition of Hard Coat Layer Coating Solution A)

| | | |
|---|---|---|
| KAYARAD DPHA | 100 | parts by mass |
| (UV curable resin, manufactured by Nippon | | |
| Kayaku Co.; a mixture of dipentaerythritol- | | |
| hexacrylate and dipentaerythritol- | | |
| pentacrylate) | | |
| KBM-5103 | 10 | parts by mass |
| (Silane coupling agent, manufactured by | | |
| Shin-etsu Chemical Co., Ltd.) | | |
| Toluene | 60 | parts by mass |
| Cyclohexanone | 40 | parts by mass |

(Preparation of Hard Coat Layer Coating Solution B)

The following ingredients were placed into a mixing tank and stirred to prepare a hard coat layer coating solution B.

(Composition of Hard Coat Layer Coating Solution B)

| | | |
|---|---|---|
| Desolite Z7401 | 100 | parts by mass |
| (zirconia microparticle-containing hard coat | | |
| composition liquid, solid content concentration: | | |
| 48% by mass; zirconia microparticle content with | | |
| respect to solid content: 70% by mass, average | | |
| particle diameter: about 20 nm, solvent | | |
| composition cyclohexanone:MEK = 5:5, | | |
| manufactured by JSR Corporation) | | |
| KAYARAD DPHA | 20 | parts by mass |
| (UV curable resin, manufactured by Nippon | | |
| Kayaku Co.) | | |
| KBM-5103 | 8 | parts by mass |
| (Silane coupling agent, manufactured by Shin- | | |
| etsu Chemical Co., Ltd.) | | |
| IRGACURE 184 | 4 | parts by mass |
| (Photo-initiator, manufactured by Ciba Specialty | | |
| Chemicals) | | |
| Methyl ethyl ketone (MEK) | 15 | parts by mass |
| Cyclohexanone | 15 | parts by mass |

(Preparation of Hard Coat Layer Coating Solution C)

The following ingredients were placed into a mixing tank and stirred to prepare a hard coat layer coating solution C.

(Composition of Hard Coat Layer Coating Solution C)

| | | |
|---|---|---|
| Desolite Z7404 | 100 | parts by mass |
| (zirconia microparticle-containing hard coat | | |
| composition liquid, solid content concentration: | | |
| 60% by mass, zirconia microparticle content | | |
| with respect to solid content: 70% by mass, | | |
| average particle diameter: about 20 nm, solvent | | |
| composition MIBK:MEK = 9:1, manufactured by | | |
| JSR Corporation) | | |
| KAYARAD DPHA | 31 | parts by mass |
| (UV curable resin, manufactured by Nippon | | |
| Kayaku Co.) | | |
| KBM-5103 | 10 | parts by mass |
| (Silane coupling agent, manufactured by Shin- | | |
| etsu Chemical Co., Ltd.) | | |
| Methyl isobutyl ketone (MIBK) | 45 | parts by mass |

(Preparation of Hard Coat Layer Coating Solution D)

The following ingredients were placed into a mixing tank and stirred to prepare a hard coat layer coating solution D.

(Composition of Hard Coat Layer Coating Solution D)

| | | |
|---|---|---|
| Desolite Z7401 | 100 | parts by mass |
| (zirconia microparticle-containing hard coat | | |
| composition liquid, solid content concentration: | | |
| 48% by mass, zirconia microparticle content | | |
| with respect to solid content: 70% by mass, | | |
| average particle diameter: about 20 nm, solvent | | |
| composition cyclohexanone:MEK = 5:5, | | |
| manufactured by JSR Corporation) | | |
| KAYARAD DPHA | 20 | parts by mass |
| (UV curable resin, manufactured by Nippon | | |
| Kayaku Co.) | | |
| KBM-5103 | 8 | parts by mass |
| (Silane coupling agent, manufactured by Shin- | | |
| etsu Chemical Co., Ltd.) | | |
| IRGACURE 184 | 4 | parts by mass |
| (Photo-initiator, manufactured by Ciba | | |
| Specialty Chemicals) | | |
| KE-P150 | 2.5 | parts by mass |
| (1.5 μm silica particle, manufactured by | | |
| Nippon Shokubai Co., Ltd.) | | |
| Methyl ethyl ketone (MEK) | 15 | parts by mass |
| Cyclohexanone | 15 | parts by mass |

Note that the above-described 1.5 μm silica particle means a silica particle having an average particle diameter of 1.5 μm. The particle is a translucent particle.

(Preparation of Titanium Dioxide Microparticle Dispersion Solution)

As the titanium dioxide microparticle, a titanium dioxide microparticle (MPT-129C, manufactured by Ishihara Sangyo Co., Ltd.) which contains cobalt and is surface-treated with aluminum hydroxide and zirconium hydroxide, was used.

To 257.1 g of the particle, 38.6 g of a dispersing agent described below and 704.3 g of cyclohexanone were added, followed by dispersion using a Dino mill to prepare a titanium dioxide dispersion solution having a mass average diameter of 70 nm.

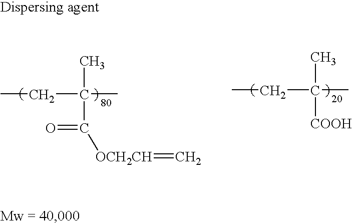

(Preparation of Medium Refractive Index Layer Coating Solution)

The following ingredients were placed into a mixing tank and stirred, followed by filtering using a polypropylene filter having a pore diameter of 0.4 μm to prepare a medium refractive index layer coating solution.

(Composition of Medium Refractive Index Layer Coating Solution)

| | | |
|---|---|---|
| Titanium dioxide microparticle dispersing | 100 | parts by mass |
| liquid | | |
| KAYARAD DPHA | 66 | parts by mass |
| (UV curable resin, manufactured by | | |
| Nippon Kayaku Co.) | | |
| IRGACURE 907 | 3.5 | parts by mass |
| (Photo-initiator, manufactured by Ciba | | |
| Specialty Chemicals) | | |
| KAYACURE DETX-S | 1.2 | parts by mass |
| (Photosensitizer, manufactured by Nippon | | |
| Kayaku Co.) | | |
| Methyl ethyl ketone (MEK) | 543 | parts by mass |
| Cyclohexanone | 2103 | parts by mass |

(Preparation of High Refractive Index Layer Coating Solution) Po The following ingredients were placed into a mixing tank and stirred, followed by filtering using a polypropylene filter having a pore diameter of 0.4 μm to prepare a high refractive index layer coating solution.

(Composition of High Refractive Index Layer Coating Solution)

| | | |
|---|---|---|
| Titanium dioxide microparticle dispersing | 100 | parts by mass |
| liquid | | |
| KAYARAD DPHA | 8.2 | parts by mass |
| (UV curable resin, manufactured by | | |
| Nippon Kayaku Co.) | | |
| IRGACURE 907 | 0.68 | parts by mass |
| (Photo-initiator, manufactured by Ciba | | |
| Specialty Chemicals) | | |
| KAYACURE DETX-S | 0.22 | parts by mass |
| (Photosensitizer, manufactured by Nippon | | |
| Kayaku Co.) | | |
| Methyl ethyl ketone (MEK) | 78 | parts by mass |
| Cyclohexanone | 243 | parts by mass |

(Preparation of Sol Liquid a)

In a reaction vessel equipped with a stirrer and a reflux condenser, 120 parts by mass of methyl ethyl ketone, 100 parts by mass of acroyloxypropyl trimethoxysilane (KBM-5103 (trade name), manufactured by Shin-etsu Chemical Co., Ltd.), and 3 parts by mass of diisopropoxy aluminum ethylacetoacetate (Chelope EP-12(trade name), Hope Chemical Co., Ltd.) were added and mixed, and thereafter, 30 parts by mass of ion exchanged water were added thereto. The mixture was allowed to react at 60° C. for 4 hours, followed by cooling to room temperature. As a result, sol liquid a was obtained. The mass average molecular weight was 1800. Among components having a degree of polymerization higher than or equal to that of oligomer components, components having a molecular weight of 1000 to 20000 account for 100%. According to gas chromatography analysis, no remaining of the raw material acryloyloxypropyltrimethoxysilane was observed.

(Synthesis of Perfluoroolefin Copolymer (1))

40 ml of ethyl acetate, 14.7 g of hydroxyethylvinylether, and 0.55 g of dilauroyl peroxide were placed in an autoclave with a stainless stirrer having a capacity of 100 ml, and the system was evacuated so that the gas phase was replaced with nitrogen gas. Further, 25 g of hexafluoropropylene (HFP) was introduced into the autoclave, followed by heating to 65° C. The autoclave had a pressure of 0.53 MPa (5.4 kg/cm²) when a temperature thereof reached 65° C. A reaction was allowed to continue for 8 hours while keeping the temperature, and when the pressure reached 0.31 MPa (3.2 kg/cm²), the heating was stopped and the mixture was allowed to stand for cooling. When the internal temperature decreased to room temperature, unreacted monomers were removed, and the autoclave was opened to remove a reaction liquid. The obtained reaction liquid was introduced to a large excess of hexane, and the solvent was removed by decantation to recover a precipitated polymer. The polymer was dissolved in a small amount of ethyl acetate, followed by reprecipitation twice to entirely remove residual monomers from hexane. After drying, 28 g of polymer was obtained. Then, the 20 g of polymer was dissolved in 100 ml of N,N-dimethylacetamide, 11.4 g of acrylic acid chloride was dropped thereto while cooling with ice, and the resultant mixture was stirred at room temperature for 10 hours. Ethyl acetate was added to the reaction liquid, followed by water washing. An organic layer was extracted and condensed. The obtained polymer was reprecipitated in hexane to obtain 19 g of perfluoroolefin copolymer (1). The obtained polymer had a refractive index of 1.421.

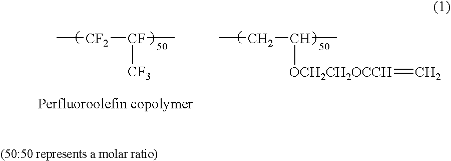

(Preparation of Hollow Silica Microparticle Dispersing Liquid)

500 parts of a hollow silica microparticle sol (particle diameter: about 40 to 50 nm, shell thickness: 6 to 8 nm, refractive index: 1.31, solid content concentration: 20%, main solvent: isopropyl alcohol, produced in accordance with Preparation Example 4 of Japanese Unexamined Patent Publication No. 2002-79616, except for a change in particle diameter) were mixed with 30 parts of acryloyloxypropyltrimethoxysilane (KBM-5103, manufactured by Shin-etsu Chemical Co., Ltd.) and 1.5 parts of diisopropoxy aluminum ethylacetoacetate (Chelope EP-12, Hope Chemical Co., Ltd.), and thereafter, 9 parts of ion exchanged water were added to the mixture. The mixture was allowed to react for 8 hours at 60° C., followed by cooling to room temperature. 1.8 parts of acetyl acetone were added to the mixture to obtain a hollow silica microparticle dispersing liquid. The resultant obtained hollow silica microparticle dispersing liquid had a solid content concentration of 18% by mass, and after the drying of the solvent, a refractive index of 1.31 .

(Preparation of Low Refractive Index Layer Coating Solution A)

The following ingredients were placed into a mixing tank and stirred, followed by filtering using a polypropylene filter having a pore diameter of 1 μm to prepare a low refractive index layer coating solution A. (Composition of Low Refractive Index Layer Coating Solution A)

| | | |
|---|---|---|
| KAYARAD DPHA | 1.4 | parts by mass |
| (UV curable resin, manufactured by Nippon | | |
| Kayaku Co.) | | |
| Perfluoroolefin copolymer (1) | 5.6 | parts by mass |
| Hollow silica microparticle dispersing | 20.0 | parts by mass |
| liquid | | |
| RMS-033 | 0.7 | parts by mass |
| (Reactive silicone, manufactured by Gelest | | |
| Inc.) | | |
| IRGACURE 907 | 0.2 | parts by mass |
| (Photo-initiator, manufactured by Ciba | | |
| Specialty Chemicals) | | |
| Sol liquid a | 6.2 | parts by mass |
| Methyl ethyl ketone (MEK) | 306.9 | parts by mass |
| Cyclohexanone | 9.0 | parts by mass |

(Preparation of Low Refractive Index Layer Coating Solution B)

The following ingredients were placed into a mixing tank and stirred, followed by filtering using a polypropylene filter having a pore diameter of 1 μm to prepare a low refractive index layer coating solution B.

(Composition of Low Refractive Index Layer Coating Solution B)

| | | |
|---|---|---|
| KAYARAD DPHA | 1.4 | parts by mass |
| (UV curable resin, manufactured by Nippon | | |
| Kayaku Co.) | | |
| Perfluoroolefin copolymer (1) | 5.6 | parts by mass |
| Silica microparticle dispersoid MEK-ST-L | 12.0 | parts by mass |
| (the same as MEK-ST, except for the | | |
| particle diameter, manufactured by Nissan | | |
| Chemical Industries Ltd.; average | | |
| particle diameter: 45 nm) | | |
| RMS-033 | 0.7 | parts by mass |
| (Reactive silicone, manufactured by Gelest | | |
| Inc.) | | |
| IRGACURE 907 | 0.2 | parts by mass |
| (Photo-initiator, manufactured by Ciba | | |
| Specialty Chemicals) | | |
| Sol liquid a | 6.2 | parts by mass |
| Methyl ethyl ketone (MEK) | 306.9 | parts by mass |
| Cyclohexanone | 9.0 | parts by mass |

(Preparation of Low Refractive Index Layer Coating Solution C)

The following ingredients were placed into a mixing tank and stirred, followed by filtering using a polypropylene filter having a pore diameter of 1 μm to prepare a low refractive index layer coating solution C.

(Composition of Low Refractive Index Layer Coating Solution C)

| | | |
|---|---|---|
| Opstar JTA113 (6%) | 55 | parts by mass |
| (polysiloxane and hydroxyl group-containing | | |
| fluoropolymer solution, manufactured by JSR | | |
| corporation; refractive index of solid content: | | |
| 1.44, solid content concentration: 6%) | | |
| Hollow silica microparticle dispersing liquid | 40 | parts by mass |
| Sol liquid a | 6 | parts by mass |
| Methyl ethyl ketone (MEK) | 240 | parts by mass |
| Cyclohexanone | 9 | parts by mass |

(Production of Anti-Reflection Film A-01)

As a support, a cellulose triacetate film having a thickness of 80 μm (TD80U, manufactured by Fuji Photo Film Co., Ltd.) was wound off the roll, and the above-described hard coat layer coating solution A was applied on the support using a gravure coater so that a dried film thickness was adjusted to become 5 μm if no mixture with the support occurs. The layer was dried at 100° C., and thereafter, was cured by irradiation with ultraviolet light having an illuminance of 400 mW/cm² and a dose of 150 mJ/cm² using a 160W/cm air-cooled metal halide lamp (produced by EYEGRAPHICS CO., LTD.) while performing nitrogen purge so that an oxygen concentration becomes 1.0% by volume or less, to form a hard coat layer 1.

The hard coat layer 1 had a refractive index of 1.54.

The support on which the hard coat layer 1 was applied and provided was wound off again, and the low refractive index layer coating solution A was applied on the support using a gravure coater so that a dried film thickness was adjusted to become 100 nm. The layer was dried at 120° C. for 150 seconds, was further dried at 140° C. for 8 minutes, and was irradiated with ultraviolet light having an illuminance of 400 mW/cm² and a dose of 900 mJ/cm² using a 240W/cm air-cooled metal halide lamp (produced by EYEGRAPHICS CO., LTD.) while performing nitrogen purge, to form a low refractive index layer 1. The coated film was wound.

(Production of Anti-Reflection Films A-02 To A-06)

Anti-reflection films A-02, A-03, A-04, A-05, and A-06 were produced in the same manner as that of the anti-reflection film A-01, except that hard coat layers were formed where the added amounts of toluene/cyclohexanone to the hard coat layer coating solution A were changed to 40 parts by mass/60 parts by mass, 20 parts by mass/80 parts by mass, 0 parts by mass/100 parts by mass, 0 parts by mass/200 parts by mass, and 100 parts by mass/0 parts by mass.

(Production of Anti-Reflection Film A-07)

An anti-reflection film A-07 was produced in the same manner as that of the anti-reflection film A-03, except that the low refractive index layer coating solution B was used to form the low refractive index layer.

(Production of Anti-Reflection Film A-08)

An anti-reflection film A-08 was produced in the same manner as that of the anti-reflection film A-03, except that the sol liquid a was not added to the low refractive index layer coating solution A.

(Production of Anti-Reflection Film A-09)

An anti-reflection film A-09 was produced in the same manner as that of the anti-reflection film A-01, except that the hard coat layer coating solution B was used to form a hard coat layer 9.

The hard coat layer 9 contained a binder containing zirconia microparticle having a refractive index of 1.62.

(Production of Anti-Reflection Films A-10 to A-12)

Anti-reflection films A-10, A-11, and A-12 were produced in the same manner as that of the anti-reflection film A-09, except that hard coat layers were formed by adding to the hard coat layer coating solution B a 5.0-μm crosslinked polystyrene particle SX-500 in an amount of 2 parts by mass, 5 parts by mass, and 10 parts by mass, respectively.

(Production of Anti-Reflection Films A-13 and A-14)

Anti-reflection films A-13 and A-14 were produced in the same manner as that of the anti-reflection film A-09, except that hard coat layers thereof were formed where the added amount of methyl ethyl ketone/cyclohexanone to the hard coat layer coating solution B were changed to 30 parts by mass/0 parts by mass and 0 parts by mass/30 parts by mass, respectively.

(Production of Anti-Reflection Film A-15)

An anti-reflection film A-15 was produced in the same manner as that of the anti-reflection film A-01, except that the hard coat layer coating solution C was used to form a hard coat layer 15.

The hard coat layer 15 contained a binder containing zirconia microparticle having a refractive index of 1.62.

(Production of Anti-Reflection Film A-16)

An anti-reflection film A-16 was produced in the same manner as that of the anti-reflection film A-09, except that the low refractive index layer coating solution C was used to form the low refractive index layer.

(Production of Anti-Reflection Film A-17)

An anti-reflection film A-17 was produced in the same manner as that of the anti-reflection film A-01, except that the hard coat layer coating solution D was used to form a hard coat layer 17.

The hard coat layer 17 contained a binder containing zirconia microparticle having a refractive index of 1.62 and a 1.5-μm silica particle having a refractive index of 1.44.

(Production of Anti-Reflection Film A-18)

An anti-reflection film A-18 was produced in the same manner as that of the anti-reflection film A-17, except that the hard coat layer was formed where the added amount of KE-P150 (1.5-μm silica particle) to the hard coat layer coating solution C was changed to 5 parts by mass.

(Production of Anti-Reflection Film A-19)

The support on which the hard coat layer 1 produced using the hard coat layer coating solution A was applied and provided was wound off, and a medium refractive index layer coating solution was applied on the hard coat layer using a gravure coater. The layer was dried at 100° C., and was cured by irradiation with ultraviolet light having an illuminance of 550 mW/cm² and a dose of 600 mJ/cm² using a 240 W/cm air-cooled metal halide lamp (produced by EYEGRAPHICS CO., LTD.) while performing nitrogen purge so that the oxygen concentration became 1.0% by volume, to form a medium refractive index layer (refractive index: 1.65, film thickness: 67 nm).

A high refractive index layer coating solution was applied on the medium refractive index layer using a gravure coater. The layer was dried at 100° C., and was cured by irradiation with ultraviolet light having an illuminance of 550 mW/cm² and a dose of 600 mJ/cm² using a 240 W/cm air-cooled metal halide lamp (produced by EYEGRAPHICS CO., LTD.) while performing nitrogen purge so that the oxygen concentration became 1.0% by volume, to form a high refractive index layer (refractive index: 1.93, film thickness: 107 nm).

A low refractive index layer coating solution A was applied on the high refractive index layer using a gravure coater. The layer was dried at 80° C., followed by irradiation with ultraviolet light having an illuminance of 550 mW/cm² and a dose of 600 mJ/cm² from a 160 W/cm air-cooled metal halide lamp (produced by EYEGRAPHICS CO., LTD.) while performing nitrogen purge so that the oxygen concentration became 1.0% by volume, to form a low refractive index layer (refractive index: 1.43, film thickness: 86 nm). In this manner, the anti-reflection layers were formed on the hard coat layer to produce an anti-reflection film A-19.

(Saponification of Anti-Reflection Film)

A 1.5-mol/l sodium hydroxide aqueous solution was prepared and kept at 55° C. A 0.005 mol/l dilute sulfuric acid aqueous solution was prepared and kept at 35°. The prepared anti-reflection film was immersed in the above-described sodium hydroxide aqueous solution for 2 minutes, and thereafter, was immersed in water so that the sodium hydroxide aqueous solution was thoroughly washed away. Next, the film was immersed in the above-described dilute sulfuric acid aqueous solution for 1 minute, and thereafter, was immersed in water so that the dilute sulfuric acid aqueous solution was thoroughly washed away. Finally, the sample was thoroughly dried at 120° C.

In this manner, a saponified anti-reflection film was prepared.

(Production of Polarizing Plates PA-01 to PA-19 with Anti-Reflection Film)

A polarizing film was produced by causing a drawn polyvinyl alcohol film to adsorb iodine. Saponified anti-reflection films A-01 to A-19 were each attached to one side of the polarizing film using a polyvinyl alcohol adhesive, where the support side (triacetyl cellulose) of the anti-reflection film was on the polarizing film side. Also, a viewing-angle widening film (wide-view film, Super Ace, manufactured by Fuji Photo Film Co., Ltd.) having an optical compensation layer was subjected to a saponification treatment, and was attached to the other side of the polarizing film using a polyvinyl alcohol adhesive. In this manner, the polarizing plates PA-01 to PA-19 were produced.

(Evaluation of Anti-Reflection Films and Polarizing Plates)

The thus-obtained antireflection films and polarizing plates were evaluated in the following categories. The results are shown in Table 1.

(1) Central Line Average Roughness Ra

Surface roughness of the anti-reflection films was measured using an atomic force microscope (AFM, SPI3800N, manufactured by SEIKO Instruments Inc.).

(2) Measurement of Layer Thicknesses of Mixed Region

The anti-reflection film was cut using a microtome, and the resultant cross-section was observed using a scanning electron microscope (S-570, manufactured by Hitachi Ltd.) in a reflection electron mode to obtain a layer thickness of a mixed region based on a captured picture.

(3) Haze

A haze values of the anti-reflection film was measured with a haze meter, MODEL 1001DP, (manufactured by Nippon Denshoku Kogyo Co., Ltd.).

(4) Degree of Transmission Image Sharpness (Image Blurring)

A degree of transmission image sharpness of the anti-reflection film was measured using an image clarity meter (ICM-2D type), manufactured by Suga Test Instruments Co., Ltd., with an optical comb having a width of 0.5 mm.

(5) Integrated Reflectance

The anti-reflection film was attached to an integrating sphere of a spectrophotometer V-550 (manufactured by JASCO Corporation) to measure an integrated reflectance thereof in a wavelength region of 380 nm to 780 nm, and an average reflectance thereof between 450 nm and 650 nm was calculated to evaluate an anti-reflection capability thereof.

(6) Irregular Interference Pattern (Rainbow Pattern)

A viewing-side polarizing plate provided in a liquid crystal display device (TH-15TA2, manufactured by Matsushita Electric Industrial Co., Ltd.), which uses a TN-type liquid crystal cell, was removed, and instead thereof, polarizing plates PA-01 to PA-19 were each attached via an adhesive so that the anti-reflection film side thereof was disposed on the viewing side and the transmission axis of the polarizing plate matched the transmission axis of the polarizing plate which had been attached to the product. In a 1000-lux bright room having a three-wavelength fluorescent lamp, the liquid crystal display device was set to display a black screen, and was evaluated by visual observation from various viewing angles in accordance with the following criteria.

(Criteria for Judging Irregular Interference Pattern)

A: no irregular interference pattern

B: substantially no irregular interference pattern

C: weak irregular interference pattern

D: strong irregular interference pattern

(7) White Blurring

In a 1000-lux bright room, the liquid crystal display devices prepared for the above-described evaluation of an irregular interference pattern was set to display a black screen, and was evaluated by visual observation from various viewing angles in accordance with the following criteria.

(Criteria for Judging White Blurring)

A: no white blurring

B: substantially no white blurring

C: weak white blurring

D: strong white blurring

(8) Goniophotometer Scattering Intensity Ratio

A scattered light profile of the anti-reflection film was measured over all directions using a GP-5-type automatic variable-angle photometer (manufactured by Murakami Color Research Laboratory), where the anti-reflection film was disposed perpendicular to incident light. The intensity of scattered light at an emission angle of 30° was measured with respect to the intensity of light at an emission angle of 0°.

(9) Variation in Hue on Right and Left

For the liquid crystal display device prepared in the above-described evaluation of an irregular interference pattern, the degree of yellow coloring in a white display was visually evaluated when a viewing angle is skewed rightward and leftward in accordance with the following criteria.

(Criteria for judging variation in hue on right and left)

A: no perceivable yellow coloring

B: slightly yellow coloring

C: weakly yellow coloring

D: strongly yellow coloring

(10) Viewing Angle

For the liquid crystal display device prepared for the evaluation of an irregular interference pattern, a measuring instrument (EZ-Contrast 160D, manufactured by ELDIM) was used to calculate the viewing angle of contrast 10 based on measurements on black and white displays.

(11) Steel-Wool Abrasion Resistance

A rubbing tester was used to conduct a rubbing test under the following conditions.

Environmental conditions for evaluation: 25° C., 60% RH

Rubbing tool: steel-wool (No.0000, manufactured by Nippon Steel Wool Co., Ltd.) was wound about the rubbing tip (1 cm×1 cm) of a tester that is to be made into contact with a sample, and was fixed with a band so as not to be displaced.

Moving distance (one-way): 13 cm, rubbing speed: 13 cm/sec, load: 500 g/cm², tip contact area: 1 cm×1 cm, number of times of rubbing: 10 reciprocations.

Oil black ink was applied on a rear side of the rubbed sample, and a rubbed portion was visually observed in reflected light to evaluate abrasions in accordance with the following criteria.

A: no abrasions noticeable despite very careful observation

B: slight abrasion noticeable

C: medium abrasion noticeable

D: abrasion noticeable at a glance

(12) Pencil Hardness

A pencil hardness test pencil was used in evaluation at load of 500 g in accordance with JIS K 5400.

TABLE 1

| | | Layer | | | Degree of | | | | | | | | |
|---|---|---|---|---|---|---|---|---|---|---|---|---|---|
| | | thick- | | | trans- | | | | | | | Viewing | |
| Anti- | | ness | Gonio- | | mission | Inte- | | | Steel- | | Vari- | angle | |
| reflection | | of | photometer | | image | grated | | Irregular | wool | | ation | up-down/ | |
| film/ | | mixed | Scattering | | sharp- | reflec- | | inter- | abrasion | Pencil | in hue | right- | |
| Polarizing | | region | intensity | Haze | ness | tance | White | ference | resis- | hard- | on right | left | |
| plate | Ra | (μm) | ratio (%) | (%) | (%) | (%) | blurring | pattern | tance | ness | and left | (degree) | |
| A-01/PA-01 | 0.02 | 0.5 | 0.001 | 1 | 98 | 1.8 | A | B | A | 4H | D | 100/134 | Present |
| | | | | | | | | | | | | | invention |
| A-02/PA-02 | 0.02 | 1.2 | 0.001 | 1 | 98 | 1.8 | A | A | A | 4H | D | 100/134 | Present |
| | | | | | | | | | | | | | invention |
| A-03/PA-03 | 0.02 | 3.1 | 0.001 | 1 | 98 | 1.8 | A | A | A | 4H | D | 100/134 | Present |
| | | | | | | | | | | | | | invention |
| A-04/PA-04 | 0.02 | 5.5 | 0.001 | 1 | 98 | 1.8 | A | A | A | 4H | D | 100/134 | Present |
| | | | | | | | | | | | | | invention |
| A-05/PA-05 | 0.02 | 8.3 | 0.001 | 1 | 98 | 1.8 | A | A | A | 3H | D | 100/134 | Present |
| | | | | | | | | | | | | | invention |
| A-06/PA-06 | 0.02 | N/A | 0.001 | 1 | 98 | 1.8 | A | C | A | 4H | D | 100/134 | Comparative |
| | | | | | | | | | | | | | example |
| A-07/PA-07 | 0.02 | 3.1 | 0.001 | 1 | 98 | 2.5 | A | A | A | 4H | D | 100/134 | Comparative |
| | | | | | | | | | | | | | example |
| A-08/PA-08 | 0.02 | 3.1 | 0.001 | 1 | 98 | 1.7 | A | A | B | 4H | D | 100/134 | Present |
| | | | | | | | | | | | | | invention |
| A-09/PA-09 | 0.02 | 2.8 | 0.001 | 1 | 98 | 1.5 | A | A | A | 4H | D | 100/134 | Present |
| | | | | | | | | | | | | | invention |
| A-10/PA-10 | 0.07 | 2.8 | 0.001 | 5 | 69 | 1.6 | B | A | A | 4H | D | 100/134 | Present |
| | | | | | | | | | | | | | invention |
| A-11/PA-11 | 0.12 | 2.8 | 0.001 | 14 | 54 | 1.8 | C | A | A | 4H | D | 100/134 | Comparative |
| | | | | | | | | | | | | | example |
| A-12/PA-12 | 0.15 | 2.8 | 0.001 | 23 | 30 | 1.8 | D | A | A | 4H | D | 100/134 | Comparative |
| | | | | | | | | | | | | | example |
| A-13/PA-13 | 0.02 | 2.2 | 0.001 | 1 | 98 | 1.5 | A | A | A | 4H | D | 100/134 | Present |
| | | | | | | | | | | | | | invention |
| A-14/PA-14 | 0.02 | 3.9 | 0.001 | 1 | 98 | 1.4 | A | A | A | 4H | D | 100/134 | Present |
| | | | | | | | | | | | | | invention |
| A-15/PA-15 | 0.02 | N/A | 0.001 | 1 | 98 | 1.5 | A | D | A | 4H | D | 100/134 | Comparative |
| | | | | | | | | | | | | | example |
| A-16/PA-16 | 0.02 | 2.8 | 0.001 | 1 | 98 | 1.4 | A | A | A | 4H | D | 100/134 | Present |
| | | | | | | | | | | | | | invention |
| A-17/PA-17 | 0.03 | 2.9 | 0.02 | 22 | 97 | 1.6 | A | A | A | 4H | B | 105/140 | Present |
| | | | | | | | | | | | | | invention |
| A-18/PA-18 | 0.03 | 2.8 | 0.03 | 40 | 96 | 1.6 | A | A | A | 4H | A | 110/143 | Present |
| | | | | | | | | | | | | | invention |
| A-19/PA-19 | 0.02 | 0.5 | 0.001 | 1 | 98 | 0.3 | A | B | A | 4H | D | 100/134 | Present |
| | | | | | | | | | | | | | invention |

(Note)
Viewing angle gives a contrast ratio of ≧10

The following are apparent from the results shown in Table 1. The low refractive index layer containing the hollow silica microparticle enhances the effect of anti-reflection. The irregular interference pattern is reduced by forming a mixed region at the interface between the hard coat layer and the support. By setting Ra to be 0.10 μm or less, white blurring and image blurring are avoided. Moreover, an irregular interference pattern can be completely eliminated by providing the medium refractive index layer.

Further, the steel-wool abrasion resistance is improved by using a hydrolysate of organosilane and/or a partial condensate thereof. The viewing angle characteristics are improved by conferring an internal scattering capability to the hard coat layer. An extremely excellent anti-reflection capability is obtained by laminating the medium, high, and low refractive index layers and the multilayered optical interference layer.

Viewing-side polarizing plates provided in a liquid crystal display device (LC-22GD3, manufactured by Sharp Corporation), which uses a VA-mode liquid crystal cell, and in a liquid crystal display device (KLV-23HR1, manufactured by Sony Corporation), which uses an IPS-mode liquid crystal cell, were removed. Instead thereof, plane polarizing plates (HLCS-5618, manufactured by Sanritz Corporation) were each attached so that the transmission axis of the polarizing plate match the transmission axis of the polarizing plate which had been attached to the product, and the anti-reflection films A-01 to A-19 were each attached by an adhesive so that the anti-reflection film side thereof was on the viewing side.

It was confirmed that, in the liquid crystal display device which uses a VA-mode liquid crystal cell, and the liquid crystal display device which uses an IPS-mode liquid crystal cell, the anti-reflection film of the present invention has an effect similar to those achieved in the case of the liquid crystal display device which uses a TN-mode liquid crystal cell.

The effect of the anti-reflection film of the invention was also confirmed in the liquid crystal cells of OCB mode shown in FIGS. 10 to 15 in JP-A-2000-154261.

(Production of Anti-Reflection Films A-20 to A-25)

Anti-reflection films A-20, A-21, A-22, A-23, A-24 and A-25 were produced in the same manner as that of the anti-reflection film A-01 except that the solvent composition of the hard coat layer coating solution A and drying air conditions of the hard coat layer were changed. The results of evaluation are shown in Table 2 below.

From the results shown in Table 2, the following facts are apparently seen. Irregular interference pattern is improved by forming a mixed region in the interface between a hard coat layer and a support. In addition, when the composition of a hard coat layer coating solution contains a solvent capable of dissolving or swelling the transparent resin of a support, and the hard coat layer coating composition is dried by drying air at a flowing rate of 10 m/second or less, irregular interference pattern is improved to a high degree.

TABLE 2

| | Hard Coat Layer | | | Anti-Reflection Film | | |
|---|---|---|---|---|---|---|
| | Composition | Drying Flow | Layer Thickness of | Ra | Irregular Inter- | |
| | of Solvent | Rate (m/s) | Mixed Region (μm) | (μm) | ference Pattern | |
| A-20 | MEK/MIBK = 80/20 | 1.0 | 2.9 | 0.02 | A | Invention |
| A-21 | MEK/MIBK = 50/50 | 0.5 | 3.2 | 0.02 | A | Invention |
| A-22 | MEK/MIBK = 50/50 | 2.0 | 1.5 | 0.02 | A | Invention |
| A-23 | MEK/MIBK = 50/50 | 5.0 | 0.9 | 0.02 | A | Invention |
| A-24 | MEK/MIBK = 50/50 | 15.0 | 0.4 | 0.02 | B | Invention |
| A-25 | MIBK = 100 | 2.0 | — | 0.02 | D | Comparison |

### INDUSTRIAL APPLICABILITY

According to the present invention, it is possible to provide an anti-reflection film which is capable of improving display visibility of a liquid crystal display or the like by preventing reflection of external light and eliminating white blurring, image blurring, a glare phenomenon, and a rainbow pattern, and which has improved abrasion resistance.

Also, the anti-reflection film of the present invention can be used as a protection film of a polarizing plate. The anti-reflection film and the polarizing plate of the present invention can be used in a liquid crystal display to allow the liquid crystal display to achieve high visibility, increase a viewing angle (particularly a downward viewing angle), and substantially eliminate contrast reduction, gradation or black-and-white inversion, and variation in hue due to a change in viewing angle.

The entire disclosure of each and every foreign patent application from which the benefit of foreign priority has been claimed in the present application is incorporated herein by reference, as if fully set forth.

1. An anti-reflection film comprising:
a support comprising a transparent resin;
at least one hard coat layer comprising an ionizing-radiation curable resin; and
a low refractive index layer disposed as an outermost layer, in this order, wherein
(i) a mixed region in which the transparent resin of the support and the ionizing-radiation curable resin of the hard coat layer are mixed is provided between the support and the hard coat layer;
(ii) the anti-reflection film has a surface roughness Ra (center line average roughness) of 0.10 μm or less; and
(iii) the low refractive index layer comprises a hollow silica microparticle having an average particle diameter of 5 to 200 nm and a refractive index of 1.17 to 1.40.

2. The anti-reflection film of claim 1,
wherein at least one of the hard coat layer and the low refractive index layer comprises:
(a) at least one of a hydrolysate of organosilane and a partial condensate thereof, the organosilane comprising a hydroxyl group or a hydrolyzable group directly linked with silicon; and
(b) at least one type of metal chelate compound comprising, as a central metal, a metal selected from Zr, Ti, and Al, and comprising, as ligands, an alcohol represented by a general formula R³OH (where R³ represents an alkyl group having one to ten carbon atoms) and a compound represented by a general formula R⁴COCH₂COR⁵ (where R⁴ represents an alkyl group having one to ten carbon atoms, and R⁵ represents an alkyl group having one to ten carbon atoms or an alkoxy group having one to ten carbon atoms).

3. the anti-reflection film of claim 1, wherein the mixed region has a layer thickness of 0.2 to 10 μm.

4. The anti-reflection film of claim 1, wherein the support is a cellulose acylate film.

5. The anti-reflection film of claim 1, wherein the hard coat layer is formed by applying, drying, and curing a coating solution comprising a solvent for dissolving or swelling the transparent resin of the support.

6. The anti-reflection film of claim 1, wherein the hard coat layer is formed by coating a coating composition comprising at least an ionizing radiation-curable resin and a solvent, and drying with drying air at a flowing rate of from 0.1 to 10 m/second.

7. The anti-reflection film of claim 1, wherein the hard coat layer has a refractive index of 1.55 or more.

8. The anti-reflection film of claim 1, wherein the hard coat layer comprises a binder and at least one type of translucent particle having a refractive index different from that of the binder.

9. The anti-reflection film of claim 1, wherein the anti-reflection film has a degree of transmission image sharpness of 60% or more.

10. The anti-reflection film of claim 1, wherein the hard coat layer has a haze value of 10% or more.

11. The anti-reflection film of claim 1, wherein, in a scattered light profile of the hard coat layer measured by a goniophotometer, an intensity of scattered light having an emission angle of 30° is 0.01% to 0.2% of an intensity of light having an emission angle of 0°.

12. A polarizing plate comprising a polarizing film having two surfaces sandwiched between protection films, wherein one of the protection films is the anti-reflection film of claim 1.

13. The polarizing plate of claim 12, wherein the other protection film that is not the anti-reflection film is an optical compensation film having an optically anisotropic layer, the optically anisotropic layer is a layer containing a compound having a discotic structural unit, the discotic structural unit has a disc surface inclined with respect to a surface of the protection film, and an angle made by the disc surface of the discotic structural unit and the surface of the protection film varies in a depth direction of the optically anisotropic layer.

14. A liquid crystal display device comprising the anti-reflection film of claim 1 as a top surface layer of a display.

15. (canceled)

16. (canceled)

17. A liquid crystal display device comprising the polarizing plate of claim 12 as a top surface layer of a display.

18. A liquid crystal display device comprising the anti-reflection film of claim 1 as a top surface layer of a display having a liquid crystal cell of VA mode or IPS mode.

19. A liquid crystal display device comprising the polarizing plate of claim 12 as a top surface layer of a display having a liquid crystal cell of VA mode or IPS mode.

20. A liquid crystal display device comprising the anti-reflection film of claim 1 as a top surface layer of a display having a liquid crystal cell of OCB mode.

21. A liquid crystal display device comprising the polarizing plate of claim 12 as a top surface layer of a display having a liquid crystal cell of OCB mode.
